(19) United States
(12) Patent Application Publication
(10) Pub. No.: US 2015/0289009 A1
(43) Pub. Date: Oct. 8, 2015

(54) REAL-TIME AUDIO MONITORING OF RADIO AND TV STATIONS

(71) Applicant: CONNECTMIX ELABORAÇÃO DE PROGRAMAS-EIRELI, São José- SC (BR)

(72) Inventors: Gelson Luis Bremm, Florianopolis-SC (BR); Jair Luiz Demarco, Florianopolis-SC (BR)

(21) Appl. No.: 14/420,214

(22) PCT Filed: Oct. 25, 2012
(86) PCT No.: PCT/BR2012/000419

§ 371 Date: Feb. 6, 2015

(30) Foreign Application Priority Data
Aug. 9, 2012 (BR) 10 2012019954-8

(51) Int. Cl. H04N 21/442; H04N 21/226; H04H 60/56; H04N 21/45

(52) U.S. Cl. CPC H04N 21/442; H04N 21/4524; H04N 21/226; H04H 60/56

(57) ABSTRACT

It's a system that monitors, in real time, audio streaming from Am, Fm, and TV stations; it uses hardware and software resources to monitor, “online” and in real time, individually and uninterruptedly, audio streams originating from the stations, detecting the execution of phonograms that are registered in a database; generating information and reports of date/time, phonogram, album, agency/artist, station, city, state and region, with all the data of initial position, final position, and length of the phonogram's identification, individual and group ranking; generates information and ISRC reports (International Standard Recording Code) individually or grouped by artist, composer, or recording label; generating information and reports of station, its geographical location, city, state, and other information.

It's a system that monitors, in real time, audio streaming from Am, Fm, and TV stations; it uses hardware and software resources to monitor, “online” and in real time, individually and uninterruptedly, audio streams originating from the stations, detecting the execution of phonograms that are registered in a database; generating information and reports of date/time, phonogram, album, agency/artist, station, city, state and region, with all the data of initial position, final position, and length of the phonogram's identification, individual and group ranking; generates information and ISRC reports (International Standard Recording Code) individually or grouped by artist, composer, or recording label; generating information and reports of station, its geographical location, city, state, and other information. It uses known signal processing techniques, pattern recognition and determining the initial position, final position, and the length of a phonogram's identification.

Different monitoring systems are known to the state of the art. Patent document US 2006/0195857 describes a system to monitor reception programs using receivers. Document EP 024853 describes a system of programming segments recognition without it having an identification code. Special attention in the similarity analysis was given to patent document PI0703682-5, which describes a method of audio identification and a system of audience measurement. It was noted:
PI0703682-5 monitors the stations accessed by the collaborators through their audience measuring “devices,” while the object described in this report monitors uninterruptedly every station contained in the monitoring process;
PI0703682-5 monitors the station's programming via a signal sent from their “devices” while the object described in this report monitors the station's programming via their audio streams;
in PI0703682-5 it is necessary to break phonograms into smaller fragments to substantially reduce the size of their digital fingerprints, while in the object described in this report the recognition algorithm is designed to identify phonograms based on their acoustic properties and it is, thus, very robust against noise and other distortions. If the entry signal is strong enough and not too distorted, a sample of only 1 second in length is enough for correct identification. Digital fingerprints based on acoustic properties are extremely small when compared to the phonogram's media files. As an example, out of a WAV phonogram that is 50.058 KB in size it is possible to extract a digital fingerprint with a size of 47 KB.
on PI0703682-5, due to the use of small fragments in creating the digital fingerprints, the initial and final positions of the identifications are obtained by “hypothesis,” calculated via approximation. In the case where many of these fragments are very similar, as it is on the choruses of songs, erroneous positioning of the initial and final positions may be obtained, while in the object described in this report it is used a digital fingerprints system which contains the numerical vectors that mathematically represent the harmonic acoustic of the phonogram in its totality, as if it were a compacted MIDI, thus it being possible to determine exactly the initial and final positions of a phonogram's identification and, from the difference between them, the total length of the identification.
PI0703682-5 monitors the audio from the channel the collaborator decides to watch or listen to, so that many stations are monitored in a single channel that is interrupted by the spectator/collaborator's command, and it doesn't monitor all stations simultaneously. Only the stations relevant to the “devices” installation location are monitored, and its data aims at an approximate statistic percentage referencing the stations that are being listened to, and not the real quantity of phonogram placements by station. In the object described in this report, it's possible to monitor thousands of stations simply by aggregating computers to the server, as the stations' audio is reproduced directly into virtual audio cables (software), a double channel (stereo) cable for each monitored station, and in full time regimen with no interruptions. Depending on the computer's processing power and on the quantity of available RAM memory, it's possible to distinctly monitor, simultaneously and uninterruptedly, up to 256 audio streams originating from radio or TV stations. As an example, we can cite tests performed in a computer with an AMD Phenom II X6 1100 T processor and 4 GB of RAM memory, running with no overclock, in which 1.800 musical phonograms with an average of 3 minutes each were monitored simultaneously in 62 stations for a period of 24 hours, utilizing 45% of the CPU's processing power and 1.9 GB of RAM memory.

Monitoring and recognizing audio content involves the manipulation of large quantities of information, grouped into distinct databases. The identification process, beginning and ending of a phonogram's execution, may suffer interruptions due to varied causes, thus generating various identification entries of the same execution of a phonogram, making the creation of reports imprecise and unstructured. To correct this problem it is described and claimed in this patent demand report an algorithm that analyses every piece of data originating from the monitoring process, making comparatives of date/time, station, phonogram, and size of the phonogram, and it mathematically verifies whether the positioning of each identification refers to a new execution of the phonogram or whether it is complementary to an earlier, interrupted identification. It also checks whether the entries should be kept or discarded at the end of each identified phonogram execution, emitting reports and information inspected in real time.

The audio stream monitoring of AM, FM, and TV stations described in this report is characterized by having a processing system, in real time, of audio signals, of connectivity data, and identification data, emitting statistical and analytical reports with degrees of complexity determined by the users/site clients themselves through multiple selections on the user's filter. In the monitoring process, except for the processes of information registration and creating a phonogram's digital signatures, all processes are automated, including turning on, rebooting, and shutting down all computers. The system manages itself, initializes and finalizes all monitoring processes, and there's no need for human intervention for the monitoring process to start or to be maintained. An administrative alert algorithm was introduced in the monitoring process to generate visual and audible alerts in the case of hardware and/or software failure occurrences that can't the bypassed by the monitoring system.

The audio transmission (streaming) monitoring of AM, FM, and TV stations described in this report has database, process reports, and emits instantaneous information crossing data from the following tables:
1. Table of identifications originating from the monitoring process.
2. Table of phonograms.
3. Table of AM, FM, and TV stations.
4. Table of cities, with latitude and longitude coordinates.
5. Table of albums.
6. Table of agencies/artists.
7. Table of musicians.
8. Table of composers.
9. Table of recording labels.
10. Table of musical genres.
11. Table of system users.
12. Table of access rules for the system's users.

The database is fixed in the server computer to allow access to all monitoring and administrative computers. There are small databases in each monitoring computer; these databases are responsible for temporarily keeping the information originating from the identifications generated during the monitoring process; this information is inspected in real time, then discarded or sent to the database on the server computer. To minimize concurrency and the excess of transactions with the database, the information generated during monitoring is sent to the server database in regular intervals managed by the monitoring controllers (CMSTREAM.EXE). This way it is possible to monitor audio and generate data simultaneously, from thousands of stations.

The table of phonograms contains the following fields: ID (unique and exclusive code), name, size (in seconds), ISRC, year, track number, date of registration, expiry period, type (advertising/musical), and relationship codes: album, agency/artist, recording label, and composer. The media files related to the phonograms receive as name the ID of their correlatives and they are saved in the server's disc in specific folders, according to their Active/Inactive expiry period.

The phonograms are identified by comparative calculations between the temporary vectors created in real time based on the audio originating from each station and the vectors previously created and saved on the digital fingerprints database; the process of creating digital fingerprints can be summarized in three steps, both for obtaining vectors in real time and for vectors that will compose the phonogram's digital fingerprints database:
1. The frequencies outside the human audible range are digitally filtered out, reducing interference noise and undesirable frequencies.
2. Using “Fourier Transform” calculations, vectors are created containing values about the musical notes (frequencies), harmonics composition, and the length of each note and of each time interval between one note and another. Thus obtaining an equivalent form of the signals in the frequency domain (DNA) of each phonogram. Therefore, it is very robust against noise and other distortions that may eventually occur in on-line phonogram recognition systems.
3. To create the digital fingerprints database, vectors are created based on the phonograms contained in the records, and these are saved in disc files and loaded into RAM memory during monitoring. For real time vectors, blocks are created straight into RAM memory as the audio is decoded in the audio channels of the stations' players. These vectors created in real time are compared to the information contained in the digital fingerprints database and discarded soon afterwards.

The stations' streaming players are automatically managed by a controller software in each monitoring computer (CMSTREAM.EXE). These controllers are responsible also: for executing tasks programmed by the system operator; for the relationship between the virtual audio cables and the stations contained in each group; for managing initialization and reconnection queue semaphores; for configuring, initializing, finalizing, and monitoring all the instances of TyMDB.exe; for the synchronized communication between the databases of the monitoring computers and server; for the coordinated rebooting and shutting down of the operational system.

The stations are connected in series in an orderly fashion, controlled by two semaphores. The first semaphore controls the initialization of each streaming player (CmPlayer.exe) and consequently its first connection. The system operator may act over the number of allowed stations on each opening of the semaphore, being able to allow just one per cycle or many simultaneously. Each semaphore cycle is defined by the sum of time spent in each initialization/connection of each of the allowed stations. The monitoring controller opens and closes the semaphore, allowing the passage of a quantity of stations that was pre-determined by the operator, and only re-opens it after all the allowed stations have initialized their players and their streaming connections. The second semaphore controls the reconnection queue. This semaphore is activated by the monitoring controller after all stations have been initialized and the initialization semaphore has been concluded and closed. All stations with unsuccessful connections, with data loading failures, or with excessive CPU usage are submitted to the reconnection queue.

The stream of each station is connected to one single player each, initialized exclusively for that station, and it may be interrupted, paused, reinitialized, have its audio levels changed or audited without it interfering with other players. A virtual stereo audio channel is initialized exclusively for each stream. An automated volume controller systematically acts over the audio of each station, stabilizing it to a level adequate for monitoring. A noise level and silence detector generates information about these occurrences. This detector also generates information about connections, connection failures, and error listings. All this information is saved on a database and made available on the website, so that users/clients can check the monitoring status in real time.

To ensure the Internet bandwidth supply is enough no matter the number of computers used in the monitoring process, and consequently the number of stations connected to on the internet, the whole system was designed so that each computer is its own autonomous monitoring unit. Each monitoring controller in each computer manages independently its streaming players, its audio inputs, and its local database. Many broadband Internet connections are utilized, shared between the monitoring computers. The input of the Internet signal happens through port redirection via Gateways, such that each monitoring computer utilizes a pre-defined internet connection, without the sharing of files between monitoring and server computers being compromised.

The audio from each virtual audio channel connected to a station is converted in real time to vectors containing its acoustic patterns in the same way used to make the digital fingerprints, the DNA of each phonogram. These vectors are compared in real time to the ones contained in the digital fingerprints database. If an identical pattern is found in the digital fingerprints database, beginning of identification data will be generated, containing date and time of the occurrence, the position where the identification started, the phonogram's code and the station's code. With this data being sent in real time to the Web database, users/clients of the website may follow in real time the identification of their phonograms while these are still being identified. The system continues to process information and to count the identification time for each identified execution, and at the recognition's ending or at the ending of the phonogram, new data is generated, this data containing the final position and the total length of each identification. The ending of an identification does not necessarily occur at the ending of the execution of a phonogram. Some identifications may represent just a fraction of the phonogram due to the interruptions created by the insertion or superposition of commentary onto the phonogram, due to modifications to the phonograms made by the stations, or due to audio failures. The algorithm that validates and synchronizes this information with the server and Web database verifies the integrity and the relationship of each information generated by the monitoring process. The algorithm creates new entries and updates existing entries, making it possible to follow in real time, step by step, the evolution of the identification of each phonogram, from beginning to ending of each execution. At the calculated ending of each execution of each identified phonogram, the entries sent to the server and Web databases are individually submitted to one last validation, where a minimum identification percentile is verified, and in case this percentile was not met, the entry is discarded and this discarding is communicated to the users/clients that are connected to the website using one of the real time monitoring tools, map or timeline.

It is claimed an algorithm that analyses each piece of data originating from the monitoring process, makes comparatives of date/time, station, phonogram, phonogram size, initial and final identification position, and mathematically verifies whether the time to conclude the execution of a phonogram has expired or is still active. In case it is still active, it tries to locate in the identifications database a previously created entry that might contain segmented information of the same execution of the phonogram, and if an entry is found it will be updated with this information, and if it is not found, and new entry based on this information will be created. In case it is inactive, it means it is a new execution of the phonogram, and a new entry will be created called identification beginning entry. This way we can ensure that even with countless interruptions on the identification of the phonograms, only one informative entry in the database will be generated for each identified execution of the phonogram. This entry will contain, among other information, the date/time, the beginning, and the ending of the identification. And for statistical purposes, it is included the number of interruptions that occurred during the identification of each execution of the phonogram.

The system is characterized as well by the formatting of reports, graphics, maps, and timelines, made available in a website so that users/clients may follow in real time or consult in a WEB database the information about the execution of their phonograms in AM and FM radios and in TV stations. And the publication of the ranking of songs that most stand out in the country, with options to individually rank by: station, artist, composer, genre, state, region, in real time or by period: week, month, and year. They are the TOP 10 and TOP 100 of music.

To complement the description of the invent and with the objective of facilitating the comprehension of its characteristics, a series of figures is presented with an illustrative and not limiting character.

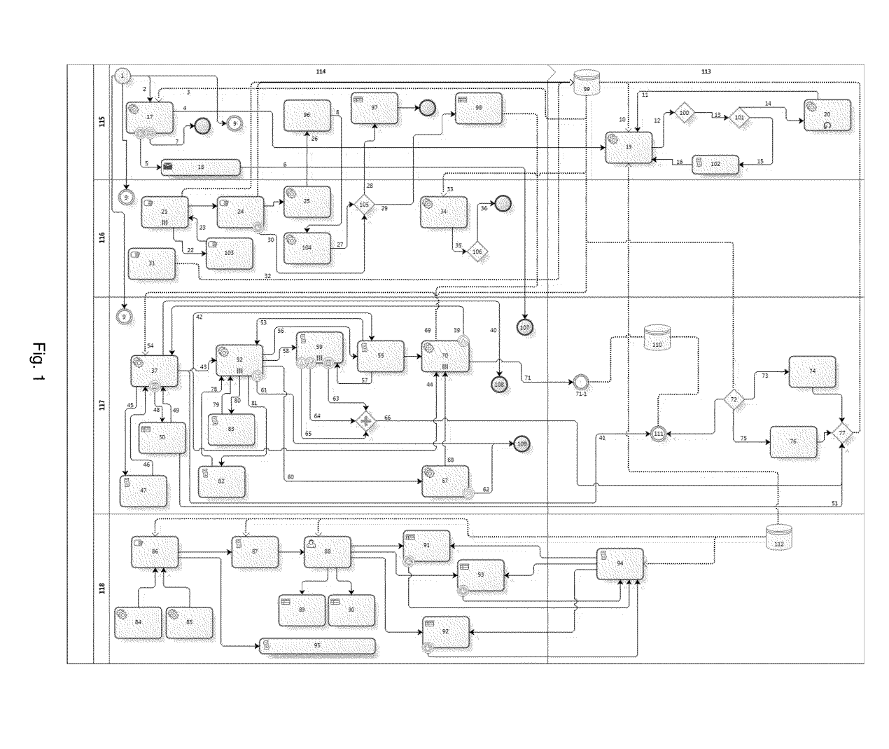

FIG. 1 is a schematic representation of the automatic monitoring system, in real time, of the audio stream from AM and FM radios and TV; it shows hardware and software grouped in a matrix form having on the lines sectors named local server sector (115), administrative sector (116), monitoring sector (117), results visualization sector (118), and two columns comprehending the Database sector (113) and the Systems and Applications sector (114).

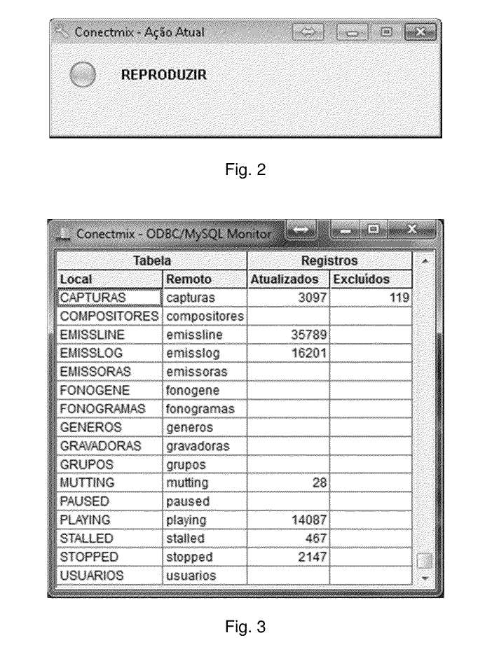

FIG. 2 shows the screen model of the SERVER SYSTEM INITIALIZATION (SERVACT.EXE), installed on the local computer server (115).

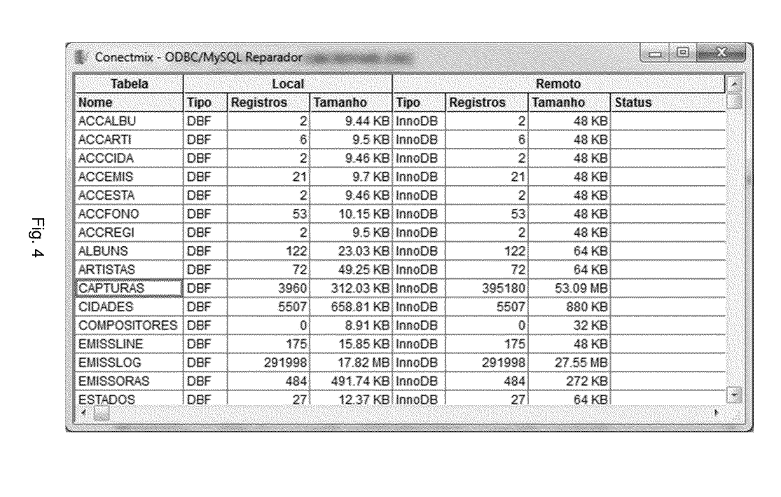

FIG. 3 shows the screen model relative to the Web Database monitoring, which synchronizes the databases between the server CPU and the web.

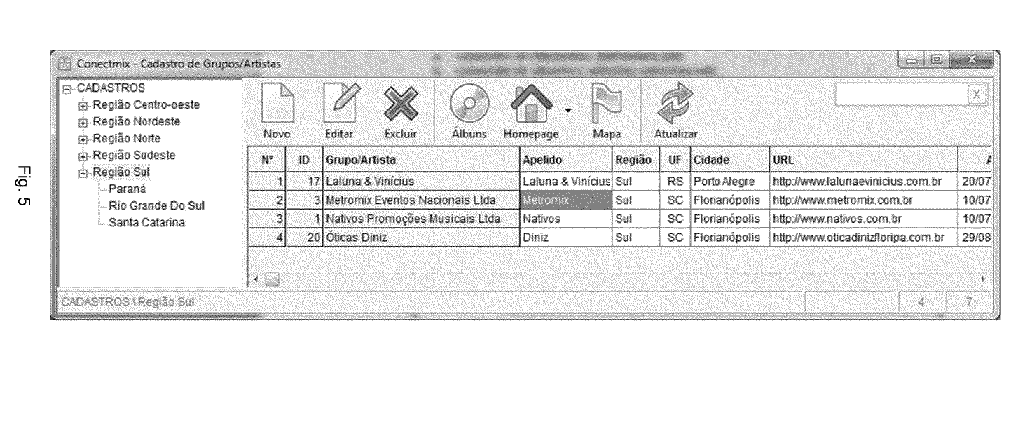

FIG. 4 shows the screen model relative to the Web Database Repairer, which synchronizes the databases between the CPU server and the web.

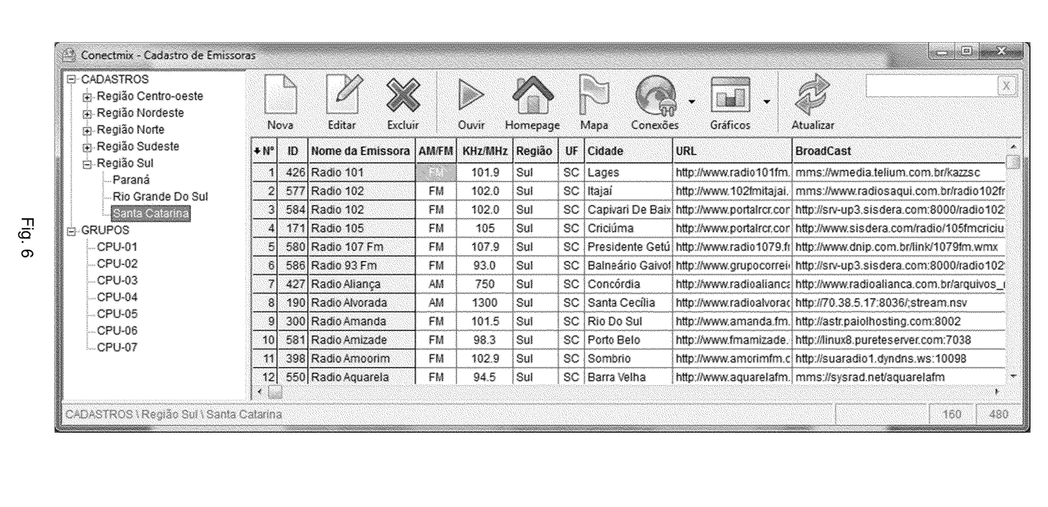

FIG. 5 shows the screen model of the Agency and Artists Records, executed by a software application named ARTISTAS.EXE, installed on the Administrative computers.

FIG. 6 shows a screen model of the Stations Records, executed by a software application named EMISSORAS.EXE, installed on the Administrative computers.

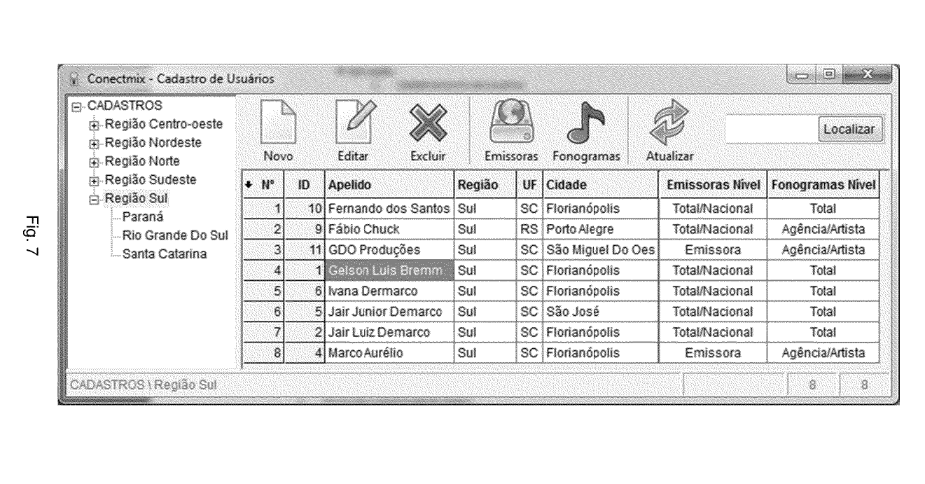

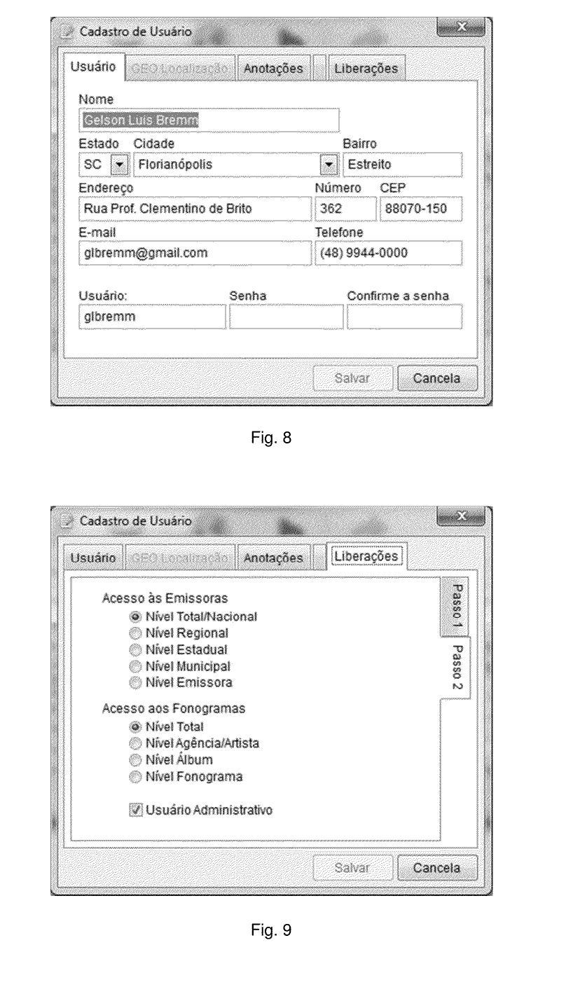

FIGS. 7 and 8 show screen models of the Users and Clients Records, executed by a software application named USUARIOS.EXE, installed on the Administrative computers.

FIG. 9 shows a screen model for emitting forms and controlling access of the Users and Clients Records-Access, executed by a software application named USUARIOS.EXE, installed on the Administrative computers.

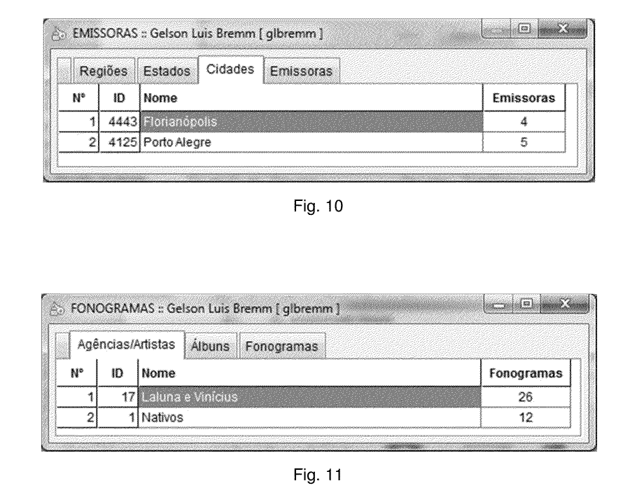

FIG. 10 shows a screen model of the stations access control form executed by the software named USUARIOS.EXE, installed on the Administrative computers.

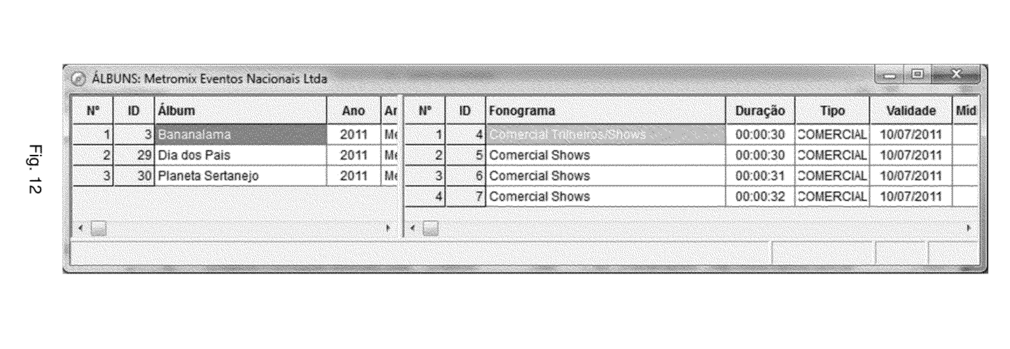

FIG. 11 shows a screen model of the phonogram user access forms, executed by the software application named USUARIOS.EXE, installed on the Administrative computers.

FIG. 12 shows a screen model of the agencies and artists control forms, executed by the software application named USUARIOS.EXE, installed on the Administrative computers.

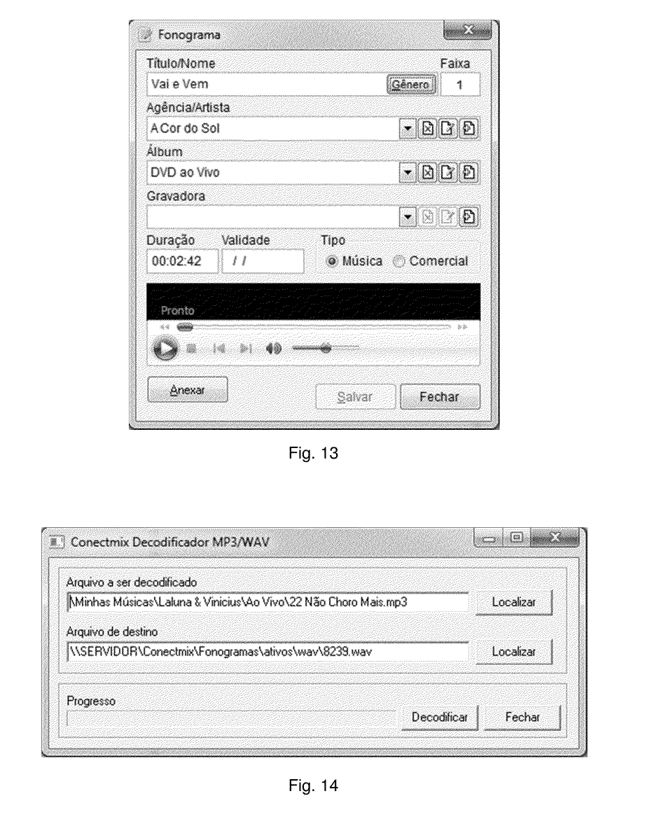

FIG. 13 shows a screen model of the phonogram entry forms, executed by the software application named ALBUNS.EXE, installed on the Administrative computers.

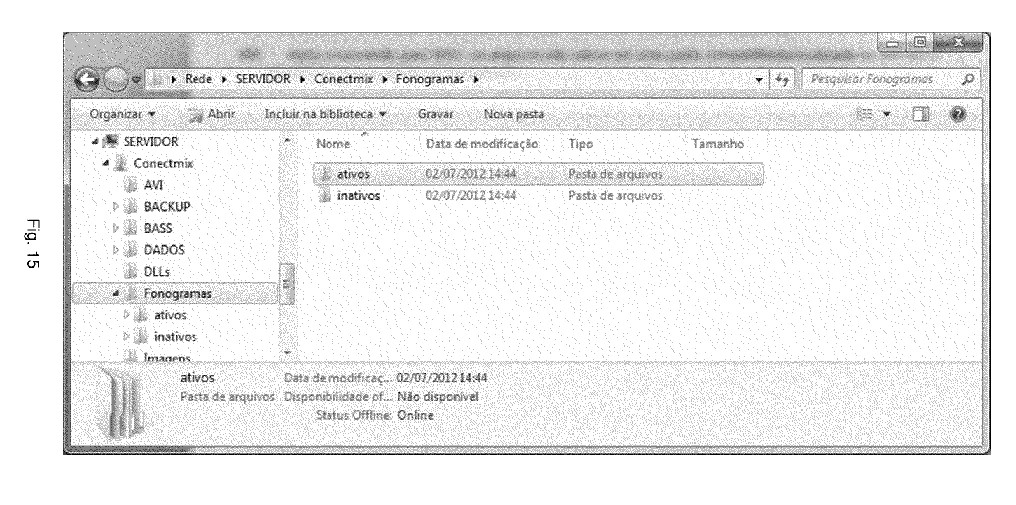

FIG. 14 shows a screen model of the conversion and standardization of mp3/wma to WAV files being executed by the software application named WRITEWAV.EXE, installed on the Administrative computers.

FIG. 15 shows a screen model relative to the digital fingerprints submitted to validation.

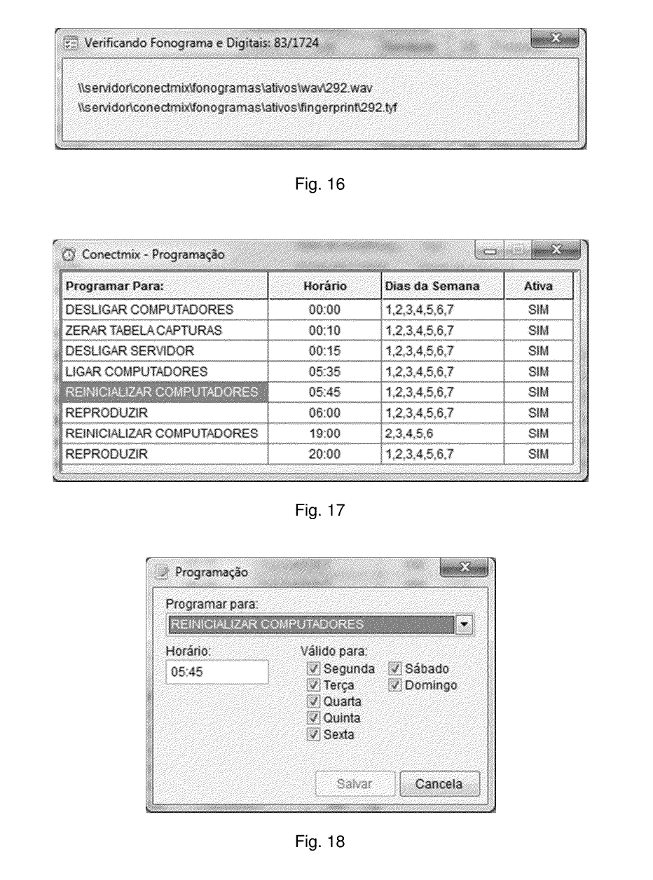

FIG. 16 shows a screen model of the Phonograms and Fingerprints verification, executed by a software application located on the Server computer and used for daily verification of active and inactive phonograms.

FIGS. 17 and 18 show screen models related to the Automated Task Configurations executed by a software application named SERVPROG.EXE, installed on the Administrative computers.

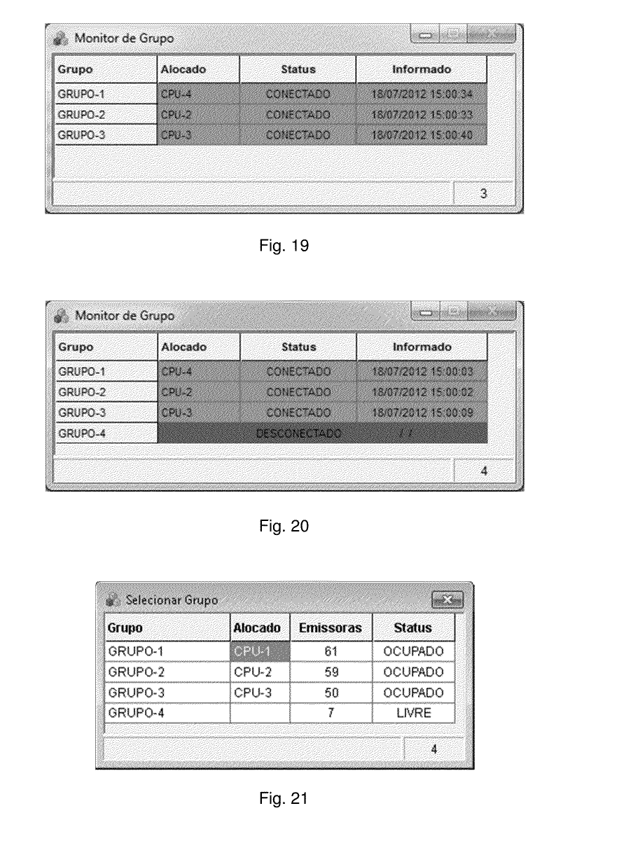

FIGS. 19 and 20 show screen models relative to the Groups Monitor, executed by a software application named MONIGRUP.EXE, installed on the Administrative computers to generate visual and audible alerts.

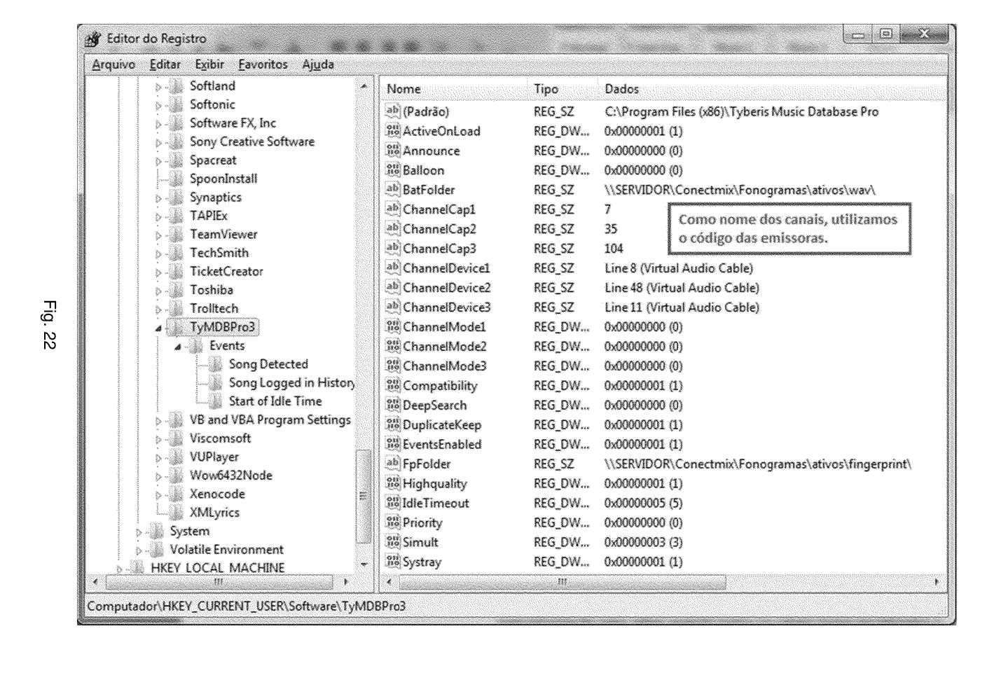

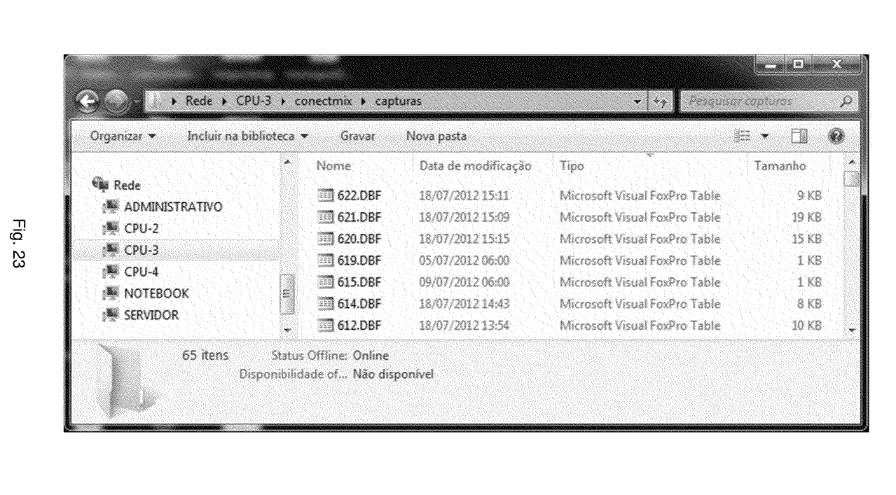

FIG. 21 shows a screen model relative to the Monitoring Controller, executed by the software application named CMSTREAM.EXE, installed on the monitoring computers.

FIG. 22 shows a screen model of the automated writing of operational system registry keys responsible for the automated parameter configurations of the TYBERIS MUSIC DATABASE (TyMDB.exe). These parameters are written by the Monitoring Controller (CMSTREAM.EXE) based on the predefined patterns defined by the system operator, and on the stations contained in the selected group.

FIG. 23 shows the screen model of the disposition of the individual tables of each station in the temporary database.

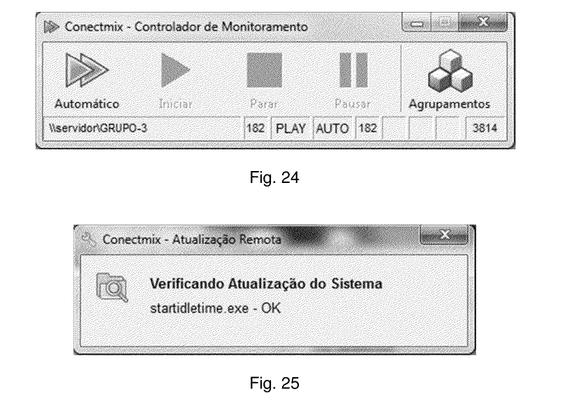

FIG. 24 shows the screen model of the Monitoring Controller (CMSTREAM.EXE).

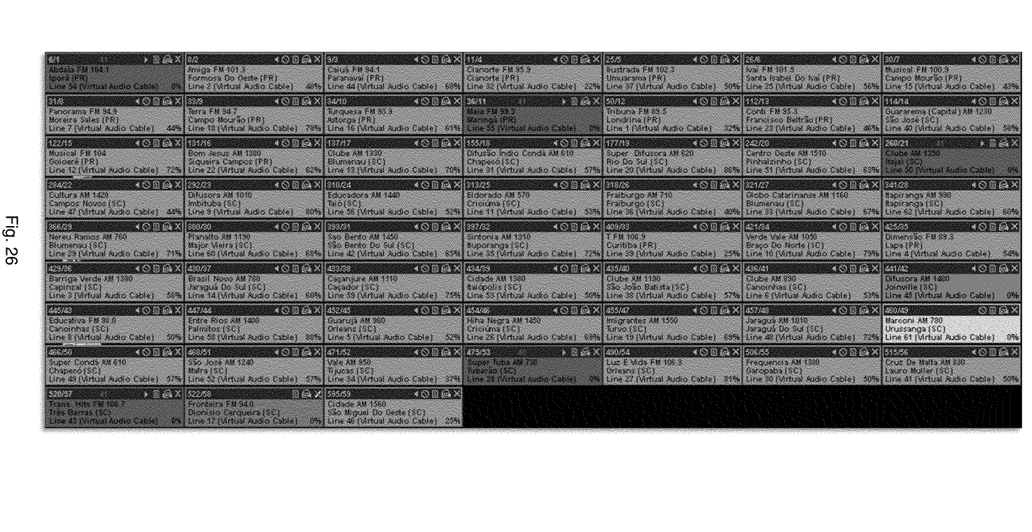

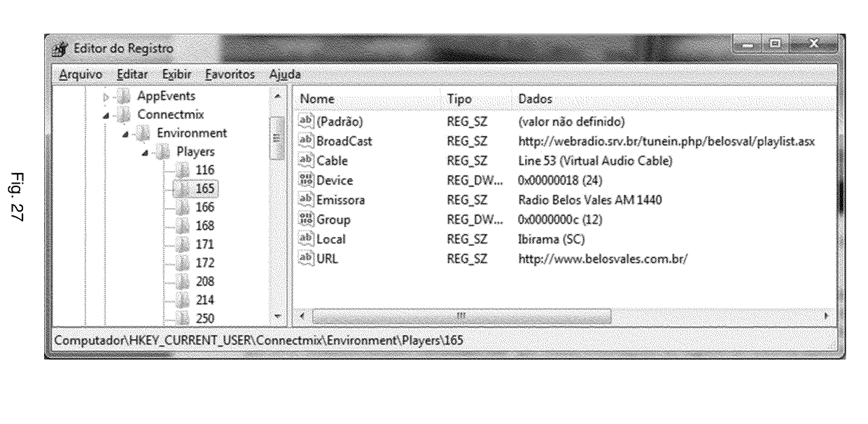

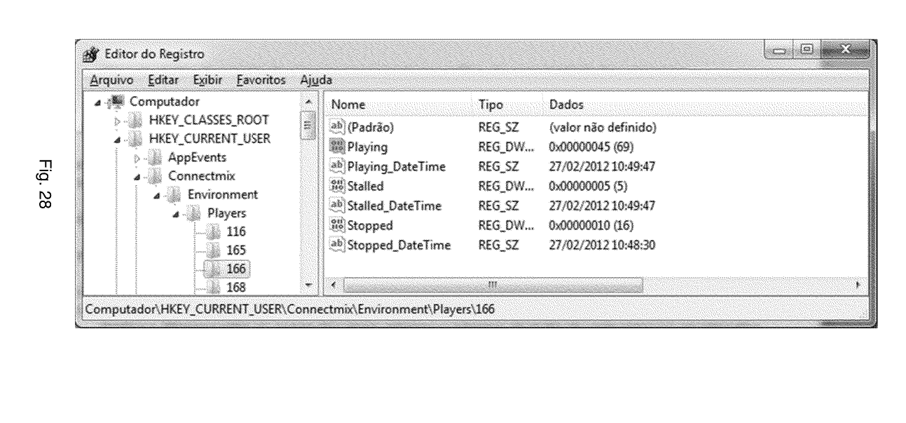

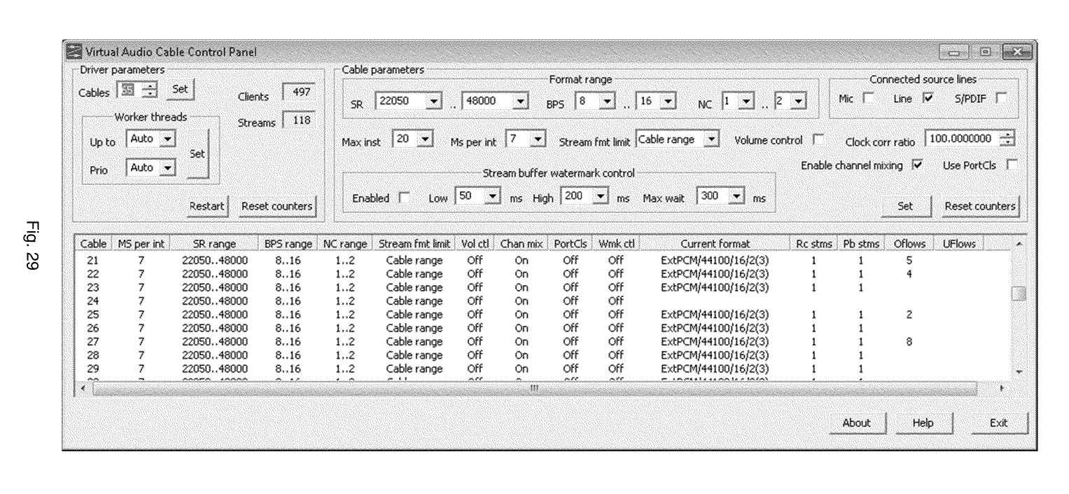

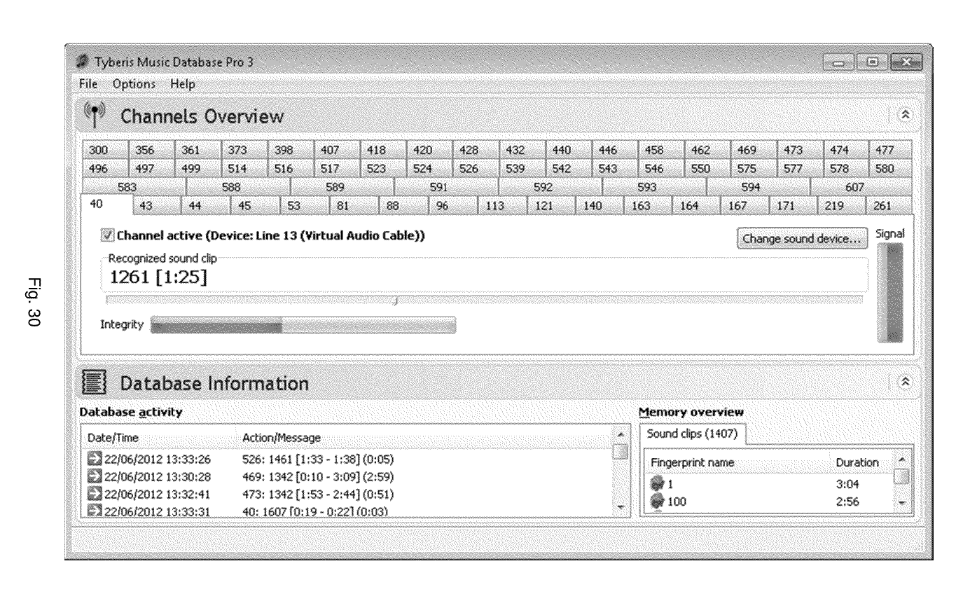

FIG. 25 shows the screen model relative to the File Updater, executed by the software named UPDATE.EXE, installed on the monitoring computers.

FIG. 26 shows the screen model of a group of 59 players (CmPlayer.exe), organized in lines and columns on the operational system's desktop.

FIG. 27 shows the screen model of the disposition of some of the data written in the operational system registry keys, responsible for the automated configuration of the audio monitoring channels of TYBERIS MUSIC DATABASE (TyMDB.exe).

FIG. 28 shows the screen model of the disposition of station connectivity data, written by the software application (CmPlayer.exe), and read, interpreted, and saved on database by the software application (CMSTREAM.EXE). This data is responsible for the information regarding audio reproduction time (connection), audio loading time, and audio reproduction stop time (disconnection).

FIG. 29 shows a screen model relative to the audio cables control panel, executed by the software named VCCTLPAN.EXE or VAC.EXE, installed on the monitoring computers.

FIG. 30 shows a screen model of the software application TYBERIS MUSIC DATBASE (TyMDB.exe), responsible for the audio identifications. Installed on the central computer and executed on the monitoring computers.

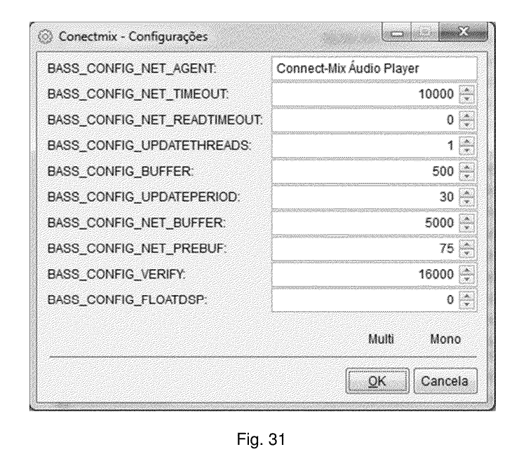

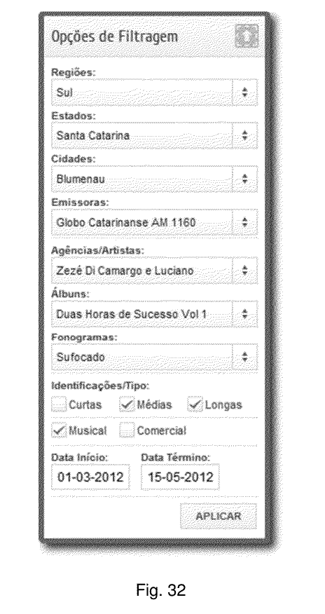

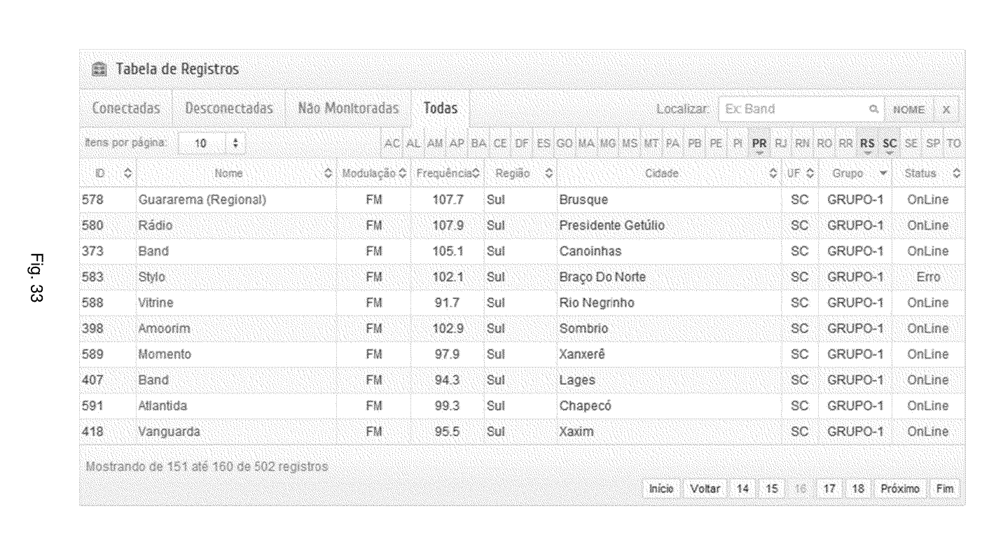

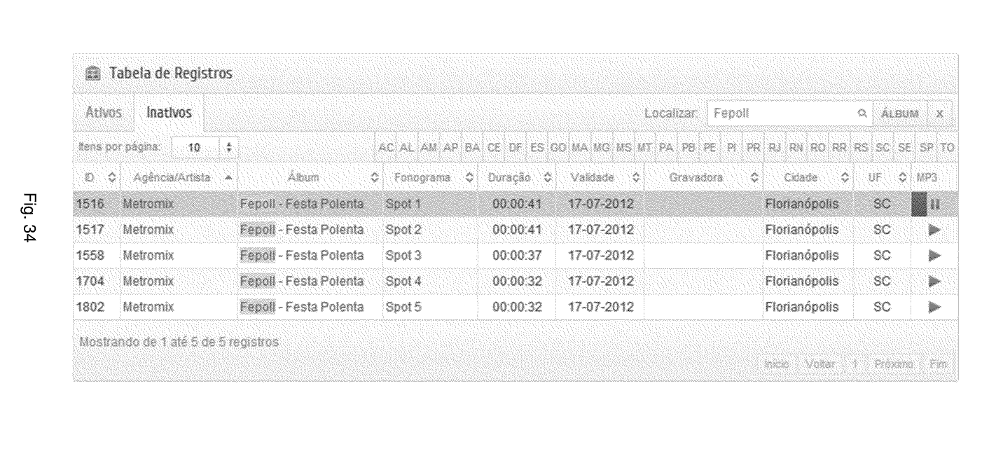

FIG. 31 shows a screen model relative to the Buffers Control, executed by the software named PLAYCONF.exe, installed on the administrative and monitoring computers.

FIG. 32 shows a screen model of the filters utilized by the user.

FIG. 33 shows a screen model of the website, of a monitored stations listing, each with their own status: on-line, off-line, or error.

FIG. 34 shows a screen model of the website, of a listing of Inactive phonograms.

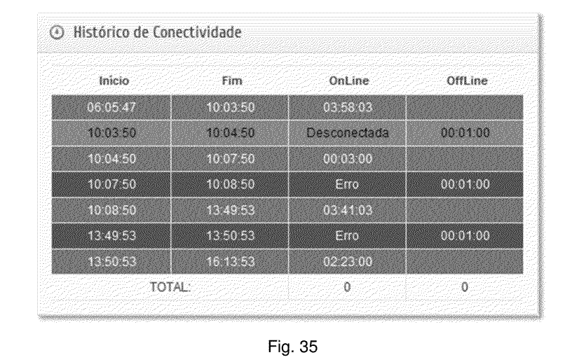

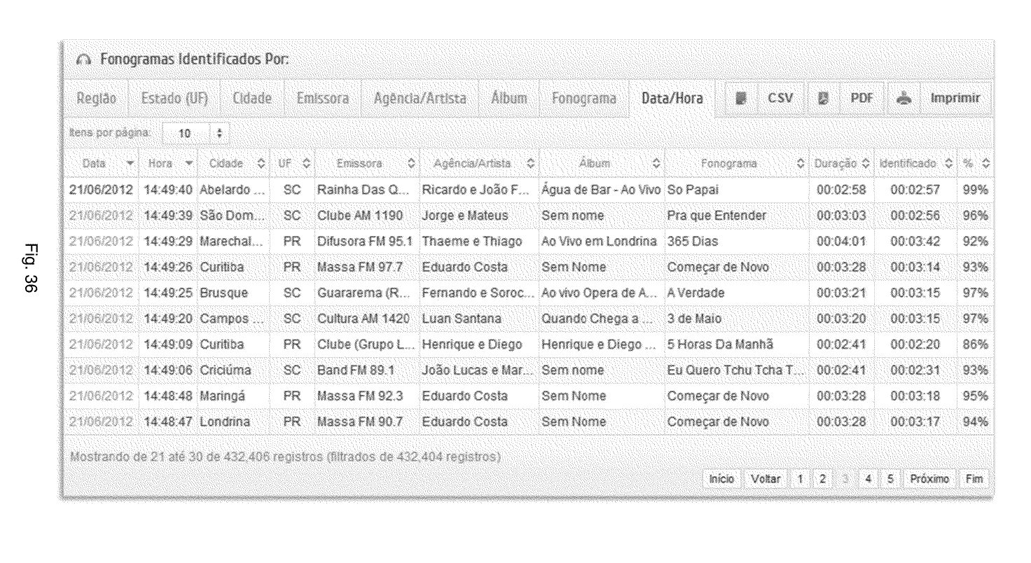

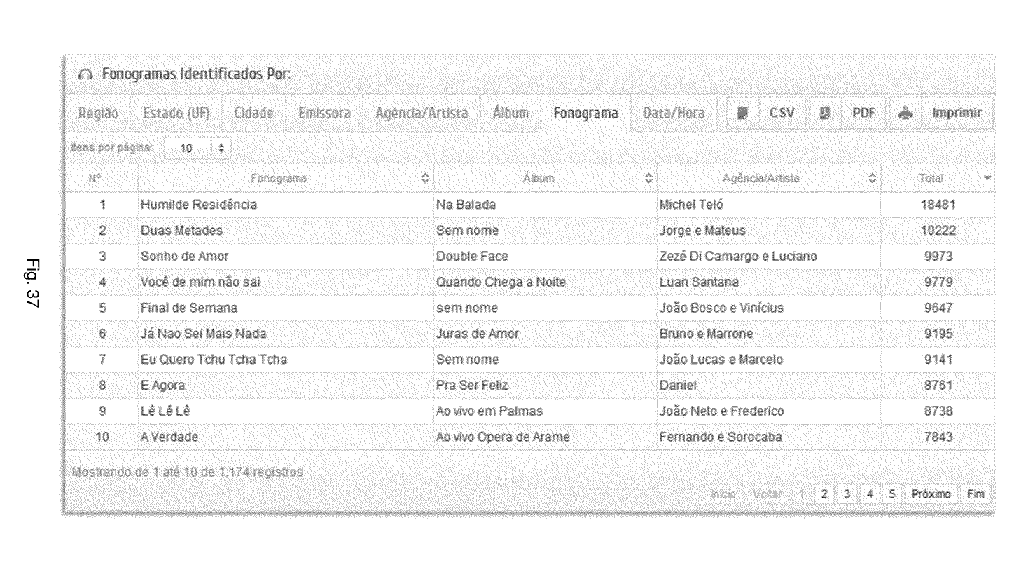

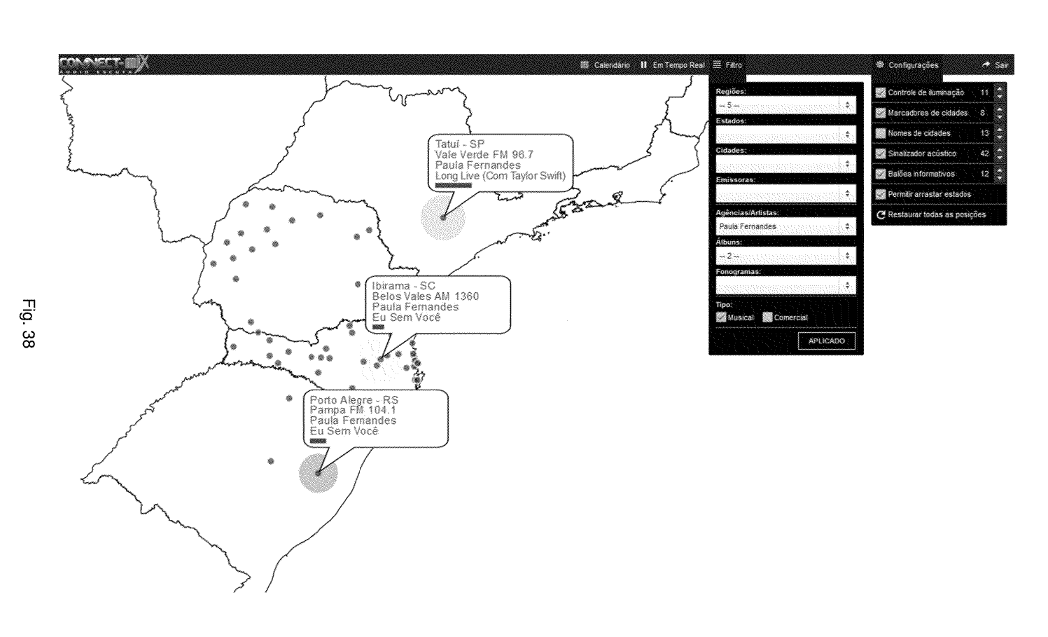

FIG. 35 shows a screen model of the website, of a listing containing connectivity history of a station in a specific date.

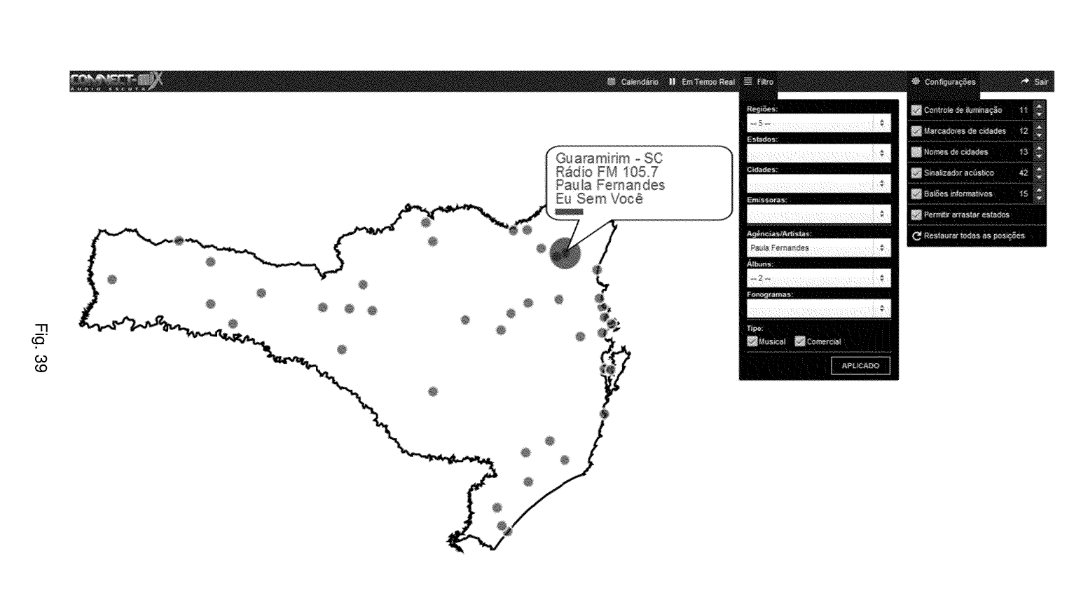

FIG. 36 shows a screen model of a table with data relative to phonograms monitoring.

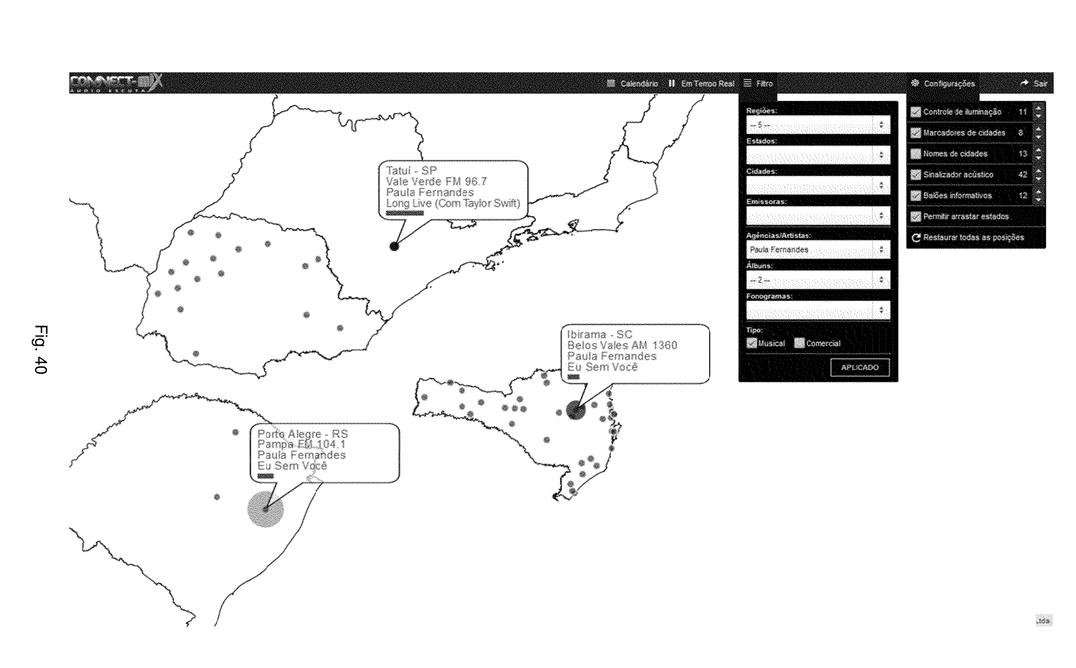

FIG. 37 shows a screen model of a table with data relative to phonograms monitoring, individually or totalized by region, state, city . . .

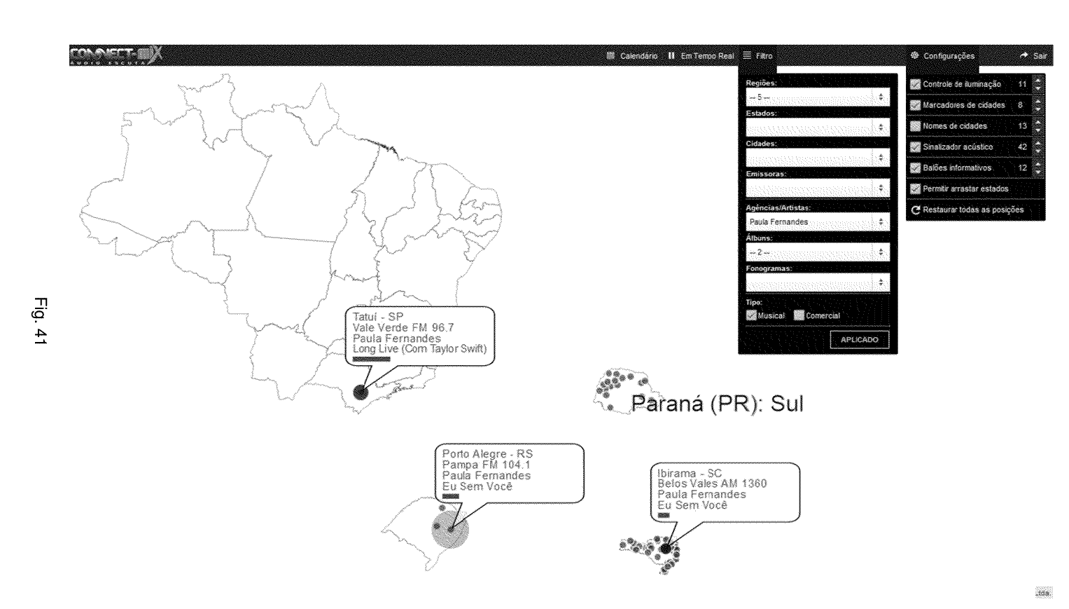

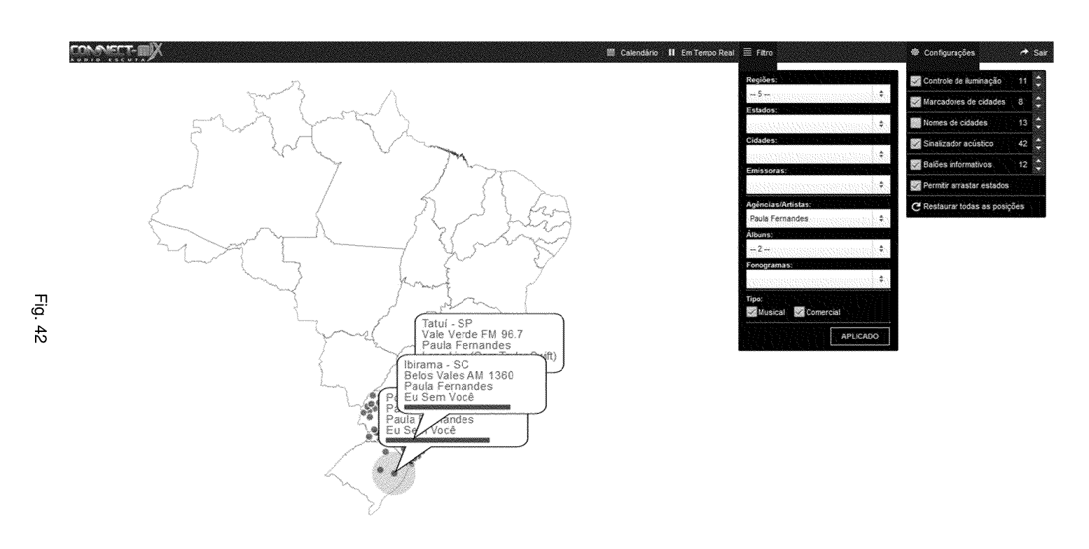

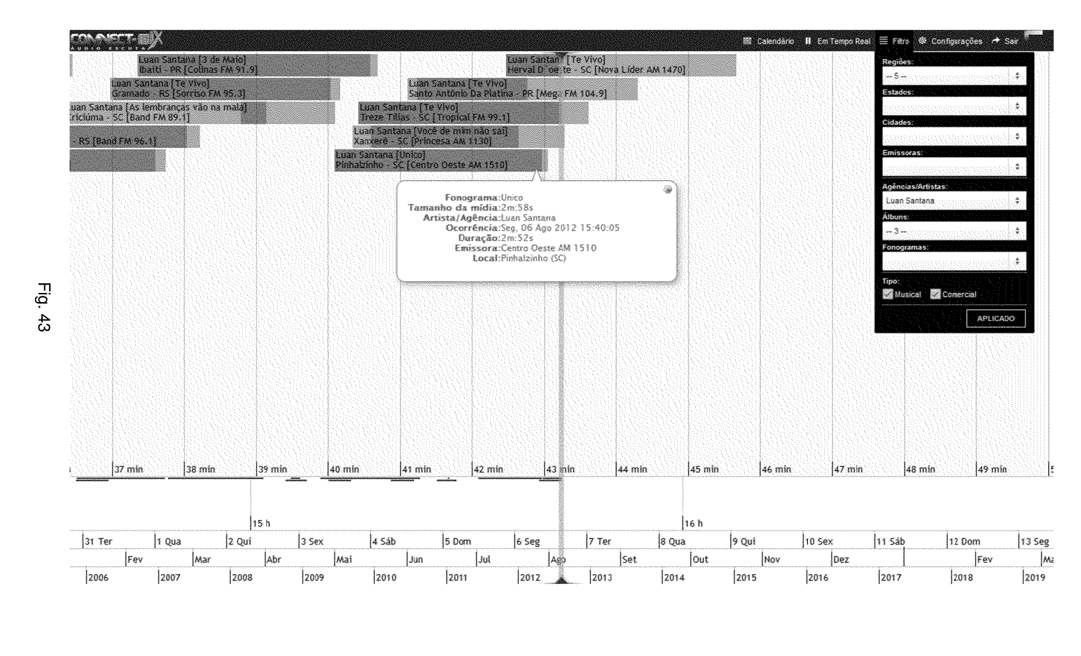

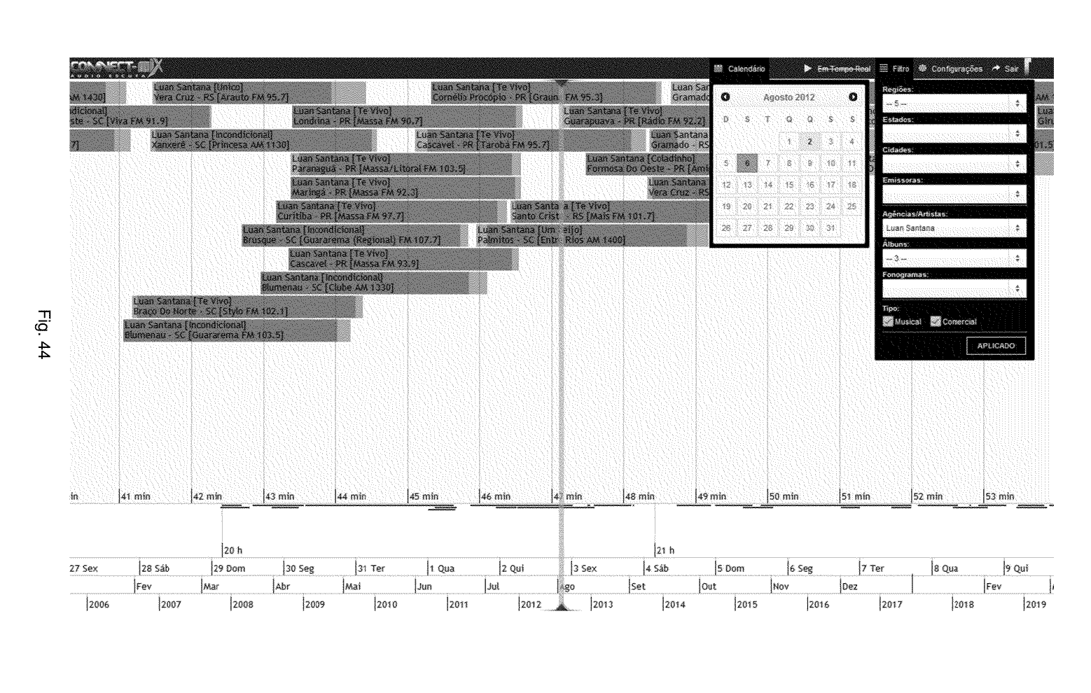

FIGS. 38, 39, 40, 41, and 42 show screen models of maps obtained in real time with identification for states, cities, stations, and other data about the monitoring process.

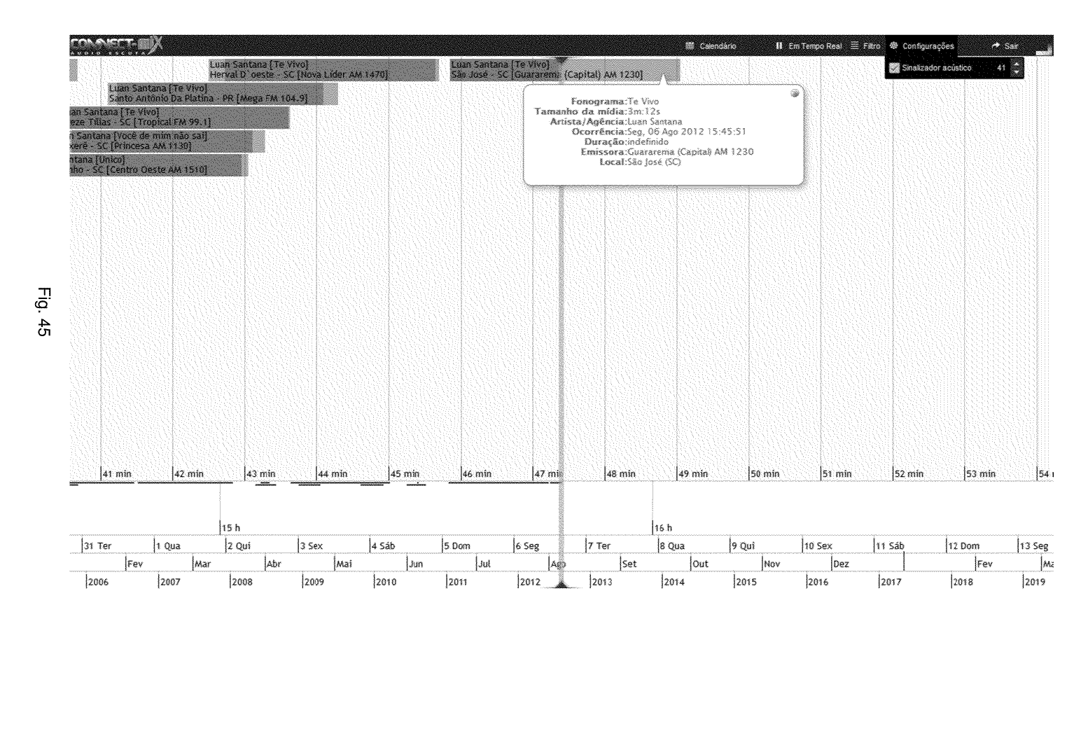

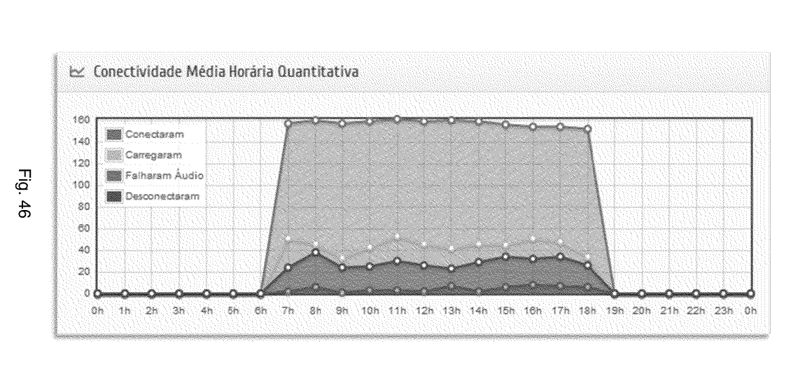

FIGS. 43, 44, and 45 show screen models simulating the sliding background pane relative to the timeline, and in scale.

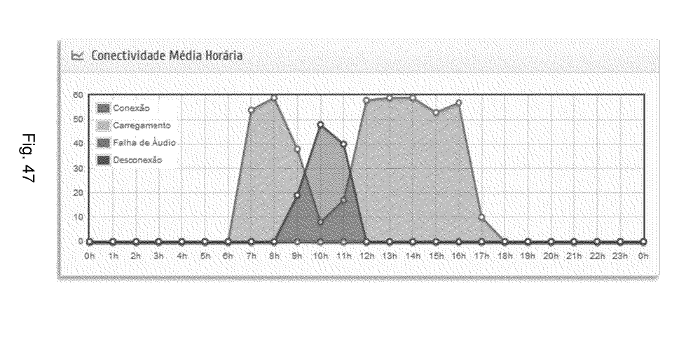

FIG. 46 shows a graphic relative to the connectivity of a group of stations.

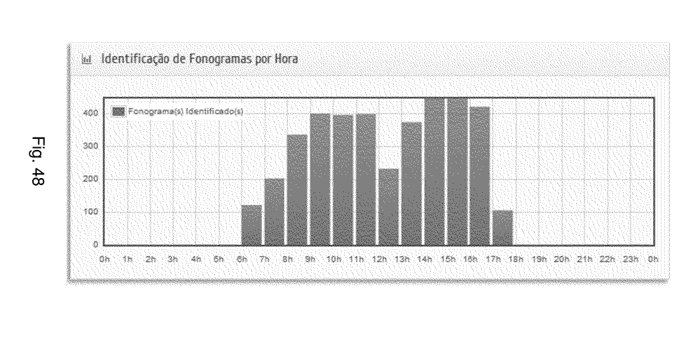

FIG. 47 shows a graphic relative to the connectivity of each station.

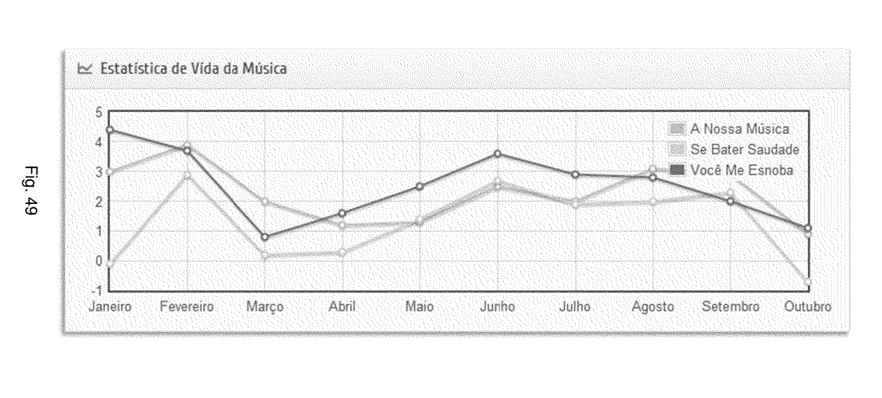

FIG. 48 shows a graphic relative to the identification of phonograms of each station.

FIG. 49 shows the life statistics of a song.

### DETAILED DESCRIPTION

According to the flowchart shown in FIG. 1 and other figures, the elements and subroutines composing the audio stream monitoring of AM and FM radio and TV were identified and described as follows:

1. The Server CPU's BIOS, with APM energy options, is programmed to turn the hardware on every day at a time pre-determined by the system operator.
2. The Server CPU's operating system initializes SERVACT.EXE, which will take control of the automated procedures involved in the whole of the monitoring process.
3. SERVACT.EXE accesses the database and initializes the selection of tasks and their chronological ordering.
4. If the chronological task is one of activity, SERVACT.EXE initializes and monitors ODBCMONITOR.EXE, which will synchronize the local database with the Web database during the whole active process of the system.
5. If the chronological task is one of activity, SERVACT.EXE initializes the sending of Wake-on-LAN (Wol) messages to wake up the monitoring computers. These messages are repeated until the computers are all awake, and it repeats in case any of the computers deliberately goes into an inactive state.
6. Wake-on-LAN messages are sent to the network cards of the monitoring computers via routers and/or switches. Messages are sent in 2.5 second intervals, taking, thus, 60 seconds to wake up 24 computers. This way the system avoids overloading the network, overloading initial concurrency with the database, and electrical overload on the No-Breaks.
7. If the chronological task is one of shutting down the server, SERVACT.EXE initializes the sending of messages to the operating system requesting it to shut down.
8. Shared access to the phonograms (songs and commercials) repository through which TyMDB.exe accesses media files and previously generated digital fingerprints (the phonogram's DNA). This is a manual process, executed by the system operator.
9. TIME SYNCHRONIZATION (CMCLOCK.EXE)—executed by a software application named CMCLOCK.EXE, installed on the Server Computer and on the Administrative and Monitoring Computers, it synchronizes operating system time through NTP servers.
10. Access to all the database tables submitted to synchronization with the remote database (Web).
11. Real time ranking data entry of the musical phonograms, originating from the accounting of TOP 10/100.
12. Access to the phonogram identifications table originating from monitoring the station's audio streams.
13. Awaits for the ending of each identified phonogram to submit it to validation.
14. Validates all phonograms that reached the minimum of 10% of identification and submits them to the TOP 10/100 accounting to calculate the ranking of each musical phonogram, ranked by: region, state, city, station, artist, and genre, taking into consideration the audience ratings of each station.
15. Marks for exclusion and synchronization all identifications not validated on the 10% rule.
16. Excludes from the database all non validated identifications.

### 17. INITIALIZATION OF THE SERVER SYSTEM (SERVACT.EXE)

Executed by the software named SERVACT.EXE installed on the server computer, it is the starting point of all automated services both for the server as well as for the monitoring computers. Its main function is to interpret the tasks scheduled by the system manager and execute them or relay them to the ones responsible. FIG. 2 shows a screen model.

18. Wake-on-LAN is a technology that allows packets to be sent with the objective of turning on machines that are inactive. Each packet contains the MAC address of the network adapter of the computer one wishes to turn on, repeated 16 times, with no interruptions.

### 19. DATABASE SYNCHRONIZATION BETWEEN SERVER CPU AND THE WEB.

a) Web Database Monitor (ODBCMONITOR.EXE)
Executed by a software application named ODBCMONITOR.EXE installed on the Server Computer, it performs the synchronization between the databases: local (server) and remote (Web). It eliminates identification entries of phonograms originating from the monitoring process that didn't reach 10% of the phonogram's length. Its operation is automatic and managed by SERVACT.EXE. FIG. 3 shows a screen model.

b) Web Database Repairer (ODBCREPARE.EXE)
Installed on the Server Computer and on the Administrative Computers, it initializes and maintains the Web database. Exclusion, creation, and optimization of the Web database's tables. Its operation is manual, requiring user intervention for repairing each intended table. FIG. 4 shows a screen model.

### 20. MUSIC'S TOP 10 AND TOP 100 (TOP.EXE)

It is a software application installed on the administrative computers and it accounts the ranking of musical phonograms. As identifications are being concluded in the monitoring process, it sends information to the database. Two ranking results are produced, one by arithmetic mean and another by weighted arithmetic mean, in which the opinion index of each station affects the end result.

### 21. DATA REGISTRATION.

1. Agencies and Artists Registration (ARTISTAS.EXE)
is a software application installed on the administrative computers and it performs registering and control of Agencies and Artists. FIG. 5 shows a screen model.

2. Musical Phonograms and Commercials Registration (ALBUNS.EXE)
It is a software application installed on the administrative computers and it performs the registration and control of phonograms. FIGS. 12 and 13 show screen models.

3. Cities Registration (CIDADES.EXE)
It is a software application installed on the administrative computers and it performs the Registration of cities, latitudes, longitudes, states, regions, and time zones.

4. Stations Registration (EMISSORAS.EXE)
Is a software application installed on the administrative computers and it performs the Registration of AM and FM radio and TV stations. It controls station groupings for the players (CMSTREAM.EXE and CMPLAYER.EXE). FIG. 6

5. Clients/Users Registration (USUARIOS.EXE)
is a software application installed on the administrative computers and it performs the Registration of users/clients for access on the website and on smartphone applications. FIGS. 7 and 8
   22. Creation and configuration of the 10 levels of user/client rights control, as well as logins and access passwords.
a) Access to the stations:
   1. Total/National Level.
   2. Regional Level (inform regions).
   3. State Level (inform states).
   4. City Level (inform cities).
   5. Station Level (inform stations).
b) Access to the phonograms:
   1. Total Level.
   2. Agency/Artist Level (inform agencies/artists).
   3. Album Level (inform albums).
   4. Phonogram Level (inform phonograms).
c) Restricted access:
   1. Administrative level (total).
Liberations control form. FIG. 9
Stations access control form. FIG. 10
Phonograms access control form. FIG. 11
   23. Relating user rights with each corresponding entry: regions, states, cities, stations, agencies/artists, albums, and phonograms.
   24. Registration of phonogram data, like: name, agency/artist, album, year, track, genre, recording label, composer, duration, and validity period.

Agencies' and artists' album control forms. FIG. 12

Phonogram registration form. FIG. 13

### 25. MP3 TO WAV CONVERTER (WRITEWAV.EXE)

is a software application installed on the administrative computers and it performs the Conversion and standardization of the mp3/wma files to WAV files with a bitrate of 1411 kbps. This conversion occurs automatically at the moment the phonogram is registered and/or has its attached media files replaced. FIG. 14

26. After conversion to WAV, the files are saved in a shared folder located on the server that is used as a phonogram repository.
27. Digital fingerprints are submitted to validation and forwarded to their respective folders according to their periods of contractual expiry. FIG. 15
28. In case the current date is not included in the validity period of the phonogram, its digital fingerprint is moved to the folder corresponding to the Inactive digital fingerprints.
29. In case the current date is included in the validity period of the phonogram, its digital fingerprint is moved to the folder corresponding to the Active digital fingerprints.
30. Phonograms are checked daily and automatically by the monitoring system, their validity dates are confronted with the system dates and, if necessary, their digital fingerprints are moved from their original positions, possible of being moved between Active and Inactive folders. The system automatically excludes the WAV files and the digital fingerprints when the relative phonogram is deleted. FIG. 16

### 31.AUTOMATED TASK CONFIGURATIONS (SERVPROG.EXE)

is a software application installed on administrative computers and it schedules the tasks the system operator configured to be automatically executed by the monitoring process. These tasks contain information regarding firing dates and times, types of events to be fired, and which application should fire them. The applications with direct dependence on the tasks schedule are SERVACT.EXE and CMSTREAM.EXE. FIGS. 17 and 18

32. All the data in the tasks schedule is saved on the server database, thus allowing all the monitoring computers, including the server, to access the same tasks and execute them at the same time.
33. Access to the database to read the stations groups table.

### 34. GROUP MONITOR (MONIGRUP.EXE)

Is a software application installed on the administrative computers that generates visual and audible alerts when a monitoring computer inadvertently interrupts its activities, be it because of hardware failure, operating system lock up, or even monitoring system crash. FIG. 19

35. The groups of stations are monitored one by one, in 10 second intervals.
36. In case a group does not inform updated data or does not inform for more than 30 seconds, it will be considered to be disconnected, and visual and audible alerts will be emitted. FIG. 20

### 37. MONITORING CONTROLLER (CMSTREAM.EXE)

Its function is to:
a) Verify on the server the existence of updates related to the monitoring system and, in case it is necessary, to finalize itself initializing UPDATE.EXE. CMSTREAM.EXE is executed again by UPDATE.EXE once the update process finishes.
b) Access the database and initialize tasks selection and their chronological ordering, like: REBOOT AND/OR SHUTDOWN THE MONITORING COMPUTERS, INITIALIZE IN EVERY COMPUTER THE MONITORING PROCESS.
c) Select the stations group relative to every computer. It identifies the MAC of every monitoring computer's network card and updates the Stations Groups table with this data. The network card's MAC is used to ensure that every stations group is always assigned to the same computer it was before, and also to direct Wake-on-LAN signals. FIG. 21
d) Verify the availability of audio cables and associate one for each station contained in the group.
e) Responsible for automating TYBERIS MUSIC DATABASE (TyMDB.EXE), automatically configuring all the required parameters it needs to work through directly writing on the Operating System registry, and also entering the codes of the stations involved and their virtual audio cables. In case the selected group contains more than 99 stations, CMSTREAM.EXE writes on the registry configurations for 99 stations, executes a copy of TyMDB.exe and waits for it to fully load, then writes the configurations for the next 99 stations and executes a second copy of TyMDB.exe, awaits for it to fully load, and then writes the configurations for the 58 remaining stations and executes a third copy of TyMDB.exe. FIG. 22
   Detailing of the operational system registry writes for the automation of TyMDB.exe
      1. Optional and personalization information.
      2. Address of the active digital fingerprints repository (Fingerprint database folder).
      3. Total number of simultaneous channels (from 1 to 99) for each copy of TyMDB.exe.
      4. For each simultaneous channel, inform as name the code of each one of the stations contained in the group, and as audio device the virtual audio channel relative to that station.
      5. Configurations for triggers/events:
         Trigger: Song Detected
         Command: c:\connectmix\songdetected.exe %date,%time,%channel,%title,%position
         Occurs: Beginning of each phonogram detection on the stations' audios.
         Trigger: Song Logged in History (Delayed) Command: c:\connectmix\songlogged.exe %date,%time,%channel,%title,%begin,%end, %duration
         Occurs: Ending of each phonogram detection on the stations' audios.
         Trigger: Start of Idle Time
         Command: c:\connectmix\startidletime.exe
         Occurs: When each channel is initialized. CMSTREAM.EXE accounts this information to know when all channels were initialized and only then opens the connections queue semaphore of the stations' stream players.
f) Create a table of data on the local database for each station contained in the selected group. These tables will temporarily contain all the data produced by TyMDB.exe and receive as name the code of each station they represent. FIG. 23
g) Request the operating system to shut down or restart the CPU.
h) Initialize/interrupt the stations' players (CMSTREAM.EXE) and monitor their functioning. FIG. 24
i) Initialize/interrupt ODBCMONITOR.EXE and monitor its functioning.
j) Supply manual initialization and total system interruption options.
k) Schedule the sending of monitoring data to the central database located on the server computer.
   38. CMSTREAM.EXE connects to the database to obtain information about the stations group it must select and the tasks schedule data.
   39. Messages originating from the Start of Idle Time event from TyMDB.exe through operating system semaphores. When the count reaches the configured number of channels, meaning all channels are connected and ready to monitor audio, CMSTREAM.EXE opens the semaphore that controls the stations' stream players.
   40. CMSTREAM.EXE sends messages to the operating system so that it will shut down or restart the CPU, depending on the tasks schedule programming.
   41. CMSTREAM.EXE controls and stabilizes the flow of phonogram identifications sent to the Server database, releasing packets from each monitoring computer in intervals of five seconds, eliminating connection concurrency errors with the database and, consequently, the loss of information.
   42. CMSTREAM.EXE writes on the operational system registry all the data required for the configuration and execution of TyMDB.exe and the stations' stream players.
   43. CMSTREAM.EXE makes controlled calls to the stations' stream players, having a connection queue of up to 256 stations per monitoring CPU. These calls are controlled by a semaphore that allows the next station to be connected to only after the one before has made its attempt. The number of stations that may be allowed on each call is pre-configured by the system administrator, so the semaphore may control one or more players per semaphore opening.
   44. CMSTREAM.EXE makes controlled calls to TyMDB.exe, configuring (writing on the operating system registry) and calling one TyMDB.exe for every 99 stations. Thus, if a group has the maximum allowed number of 256 stations, 3 TyMDB.exe will be individually called and configured.
   45. CMSTREAM.EXE monitors on the server the existence of updates for the files and applications related to the monitoring system, and if necessary performs a call to UPDATE.EXE, which is responsible for all updates including CMSTREAM.EXE.
   46. UPDATE.EXE calls CMSTREAM.EXE when the updates are finished.

### 47. FILE UPDATER (UPDATE.EXE)

Installed on the Monitoring Computers, it has the function of updating files and applications relative to the monitoring system on the monitoring computers. When executed, it forces the ending of all applications related to the monitoring process, and after the updating process concludes, it calls CMSTREAM.EXE, reinitializing the whole monitoring process. FIG. 25

48. Manual selection of stations group. Needed only on the first execution of each group, or in reallocating the group to another CPU.
49. Manual selection of stations group. Through the MAC address of each network card previously saved on the data of each group, CMSTREAM.EXE selects automatically the same groups for the same CPUs.
50. Lists all groups available on the stations registration. Allowing the selection of just one group of stations per monitoring CPU. Associates each group with the MAC of the network card from the CPU that it was allocated to.
51. Sends to the server database the MAC data of each monitoring network card associated to the code of each stations group.

### 52. CONNECT-MIX RADIO PLAYER (CMPLAYER.EXE). FIG. 26

is a software application installed on the monitoring computers, and it is characterized by:
1. Connecting the stations from the selected group to their virtual audio cables.
2. Connecting the stations from the selected group to the streaming URLs and initializing the audio reproduction.
3. Update the database minute by minute with statistical information about: connection failures, connection time, load time, audio reproduction time, and disconnections for each station of the group.
4. Manage its own use of CPU and allotted memory, reinitializing degraded connections and freeing all reserved memory that is not utilized or discarded, allowing the largest possible amount of players per computer with the least use of memory and of processing power.
5. Update in real time the status: on-line, off-line, and error for each station of the group.
   I. Yellow: loading.
   II. Red: error.
   III. Maroon: connecting.
   IV. Green: connected, reproducing audio.
   V. Gray: silence, or excessive noise.
      a. Through analysis of the high and low audio levels on the audio channels of each station, an automatic volume control has been programmed that recalculates audio signal levels at every second, and a linear leveler performs the decrease or increase in volume of every station uninterruptedly. if the potential difference between maximum and minimum peaks do not reach a value we consider satisfactory, the station's audio will be considered insufficient to ensure the integrity of the information, and the player will inform statistical data about these occurrences.
      b. Through analysis of the predominating audible frequencies gamut and the ptoential difference between minimum and maximum peaks, we have programmed an automatic noise and silence level control. If the potential difference between minimum and maximum peaks do not reach a significant value and the gamut of audible frequency remains stable at every data capture, the station's audio will be considered deficient to ensure the integrity of the information, and the player will inform statistical data about these occurrences.
         53. Reading of data written by CMSTREAM.EXE on the operational system registry. Data is disposed in Keys named after the stations' codes contained in the selected group, and every key/station contains a list of data necessary for each streaming player to proceed with connecting to the station without the need to connect to the database. FIG. 27
         54. Connection with the server database.
         55. Central operating system database that holds definitions, configurations, and other information we use in our monitoring system as a support database, thus allowing 256 stations to be monitored with only a single database connection per CPU, established on CMSTREAM.EXE, that collects information originating from the players through the operating system registry and sends them to the server database in regular and optimized intervals.
         56. CMPLAYER.EXE, writing on the operating system registry information about data loading times (audio download), connection and disconnection. These values are written in 60 second intervals and represent the sum of seconds related to each state, and that will compose the connectivity graph of each station every minute. FIG. 28

Example. (FIG. 28)
From 10:48:47 to 10:49:47 occurred:
   5 seconds of loading (Stalled).
   45 seconds of audio reproduction (Playing).
   10 seconds of disconnection (Stopped).
      57. Obtaining operating system registry data to analyze station connectivity.
      58. Sending decoded numerical data from the audio channel for silence and excess noise analysis.
      59. Connectivity analysis converts information related to the stations' connection status and audio quality into statistical data for the connectivity graphs.
      60. CMPLAYER.EXE, reproduces the flow of audio data obtained from the stations' streaming URLs and sends it to the related virtual audio channels, as if each station's broadcast were being played through a sound card exclusive to that station.
      61. Audio input for manual monitoring and auditory quality analysis of a connection's audio. The signal is cloned and rerouted to the operating system speakers.
      62. Audio input for manual monitoring and auditory quality analysis of the virtual audio cables. The signal is cloned and rerouted to the operating system speakers.
      63. Calculation for each station of the difference between the sum of the last 60 seconds for loading times, audio reproduction times, and disconnection times. Whichever value is larger will inform the connection status, which may be 1 (On-line) or 0 (Off-line).
      64. Analysis of the difference between the sums of minimum and maximum audio levels of each station in pre-determined time intervals. In case results do not reach the minimum expected values, the stations in question will have their status changed to Silence, which means connected but with no audio. The stations set to silence status will not stop being monitored, but it will be noted in their connectivity history that in determined moments they were mute.
      65. Continuity analysis between the minimum and maximum audio frequency gamut, in pre-determined time intervals. In case the results are very close and generally stable, the stations in question will have their status set to Noise, which means connected but with excessive noise in the audio. Stations with the noise status will not stop being monitored, but it will be noted in their connectivity history that in determined moments they had audio quality problems.
      66. All the information generated during monitoring analysis is transformed in data and sent to the server database.

### 67. VIRTUAL AUDIO CABLE (VCCTLPAN.EXE or VAC.EXE)

Installed on the Monitoring computers with the function of virtualizing the audio cables (one for each station included in the selected group). It has a maximum virtualization capacity of 256 audio cables. FIG. 29

68. TyMDB.exe, receiving audio from the stations' players through the virtual audio cables. In case it is necessary to configure and call many instances of TyMDB.exe, each will monitor only the audio cables relative to the stations configured in its monitoring channels.
69. TyMDB.exe, accessing the active digital fingerprints repository (shared folder on the server). Access is given by the “Fingerprint database folder” configuration written on the operation system registry by CMSTREAM.EXE.
70. TYBERIS MUSIC DATABASE (TYMDB.exe)

Installed on the monitoring computers, it has the function of generating digital fingerprints of songs and commercials (phonograms), analyzing the audio from the stations connected to its monitoring channels by looking for harmonic sequences coincident with the ones contained in the active digital fingerprints database, and generating information of date/time, beginning and end of each identification, as well as the internal positioning of the phonogram relative to the identified sequence. FIG. 30

Note: Depending on the quality of the audio received from the stations' streams, or in case their phonograms contain commentaries and/or personalization added by the station, countless identifications for the same execution of a phonogram may occur, and in this case each interrupted identification refers to one interrupted part of the same identification of a phonogram. In other cases, tiny identifications may happen throughout and these will be discarded during the process. So that the system offers reliable information to the website's and smartphone applications' users/clients, all data generated during monitoring is processed afterwards, during synchronization with the server database.

71. All information generated during the identification of phonograms by TyMDB.exe is sent to two Connect-Mix plug-ins, and from these plug-ins they are added with no further processing to a local, temporary database in which each monitored channel (station) has its own data table, thus avoiding failures to access the data table due to excessive concurrency. In this manner, even with 256 stations by monitoring CPU, there will be no access concurrencies to the database, because it is not possible for a station to be concurrent with itself for access to its own data table. The data inserted in the tables originates from the triggers Song Detected and Song Logged in History (Delayed), each channel received as name the code of the relative station and, thus, the table for each channel will also receive this code as name. The plug-ins connected to these triggers: songdetected.exe e songlogged.exe will insert the data in the tables corresponding to the monitored channels (stations) and may insert simultaneously into the 256 tables of the database of each CPU without loss of performance or loss of data.

### 71-1. PLUG-INS CONNECTED TO THE EVENT TRIGGERS OF TYMDB.EXE (SONGDETECTED.EXE, SONGLOGGED.EXE AND STARTIDLETIME.EXE)

installed on the monitoring computers, are responsible for the communication between TYBERIS MUSIC DATABASE and the Connect-Mix Database. They insert information obtained for a temporary database located in each monitoring computer and send them to the server database only after processing them, primarily detecting possible discontinuations of a previous identification, that is, even if TYBERIS presents many identifications to one same phonogram/station reproduction, in the end we will have only one entry containing the sum of the whole identifications sequence, with beginning, end, duration, and the amount of breaks that occurred until the phonogram's expected ending. These occurrences are typical for musical phonograms containing station signatures, connection failures, audio failures, etc.

1. SONGDETECTED.EXE. Is fired by the event Song Detected from TYMDB.EXE which means the beginning of a phonogram identification on a station's audio. This information may be flawed, since it does not have enough length to ensure its veracity. It simply indicates the possibility of a new occurrence.

2. SONGLOGGED.EXE. Is fired by the event Song Logged in History (Delayed) from TYMBD.EXE which means the ending of a phonogram identification on a station's audio. This information has integrity, since it has significant length which shows the phonogram was identified for X seconds, with possible variations in case of a loss of identification, until the total length of the phonogram.

3. STARTIDLETIME.EXE. Is fired by the event Start of Idle Time from TYMBD.EXE which means the loading of a channel is finished. This event is fired for each conclusion of a channel's loading. This plugin must account for this information to be certain that all the channels are concluded, and only then it informs the monitoring controller that the initialization queue semaphore can be initialized.

72. The data contained in the local, temporary database tables is processed in regular intervals controlled by CMSTREAM.EXE. Since many entries may be generated for one same identification of a phonogram, and since what is expected is to have only one entry for each identification, we need to calculate based on the current time, duration time of each phonogram, and initial position of each identification already entered on the server, the exact beginning and ending time of a phonogram's placement and check if the temporary entries are contained inside or outside of any of these intervals. In case they are, and they originate from the same channel and phonogram, then they are recurrent entries, complementary of one same interrupted identification. Otherwise, it is the beginning of a new identification. With many monitoring CPUs, and with each monitoring 256 stations, it is necessary to speed up the recurring entries search process, which is why we do not use indexes in this process, so as not to waste time updating them, since the amount of data sent to the identifications table is too large and the time interval too small. Thus, the search for recurring entries does not use the LOCATE command present in the Microsoft Visual FoxPro language. The search is made by moving the entry pointer to the last entry on the table, comparing data, and moving the pointer backwards until an entry compatible with complementation is found, until the pointer moved beyond the identification's starting point, or until it reaches the top of the table. This technique has shown itself to be 39 times faster than the same search using the LOCATE command, and it has been one of the main keys for the perfect maintaining of the graphs, timelines, and maps in real time for the users of the website and smartphone applications.
73. The entry contained in the local, temporary database is not contained in the interval of another identification already present in the server database, or it is contained but does not correspond to the same channel or phonogram.
74. Creates a new phonogram identification entry in the server database, containing the date and time it was identified, the station code, the phonogram code, and initial and final identification positions, and the length of the identification.
75. The entry contained in the local, temporary database is contained in the interval of another identification already present in the server database, and it corresponds to the same channel and phonogram.
76. Updates the phonogram identification data located in the server database, incrementing the final position and identified time length. In the end, the entry contained in the server database should contain the sum of all interrupted identifications of one same placement of a phonogram.
77. The data synchronization originating from the monitoring process, the phonogram's identifications, the statistical connectivity information, and other data generated or acquired in each monitoring CPU, is sent to the server database by a subroutine on CMSTREAM.EXE and its connection to the server database.
78. Amplitude control feedback on the audio signal output originating from the automatic volume control.
79. Automatic buffers control feedback, time directives, and quantities that shall be followed by the stream player.
80. Data requisition of the audio input and output channels from the stations' streams.
81. Sending of numerical data relative to the audio amplitudes to the automatic volume control.
82. Automatic volume control. Obtains the arithmetic mean of 10 audio level readings per second, decreasing or increasing volume until the mean obtained is within an interval of pre-determined values. Volume alterations occur gradually, through a linear stabilizer that adjusts ¼ of the value to be compensated per second. Each station's audio streaming player has its own automatic volume controller.

### 83. BUFFERS CONTROL (PLAYCONF.EXE)

Installed on the Administrative and Monitoring Computers, it defines generic control parameters to all players in all monitoring computers, such as: data reading time, give up time in case of error, amount of data per requisition, requisition interval, amount of data sent to the audio decoders, time interval for sending data to the decoders, queue/semaphores behavior, processor usage, and memory usage. FIG. 31

Note. When one works with significant quantities of audio streams, the necessity of having rigorous control over the audio channels' buffers is indispensable, since it is necessary to control the quantity of data downloaded from each stream and the time interval between data requests. It is necessary to control the amount of data sent to the decoders and to the audio reproduction and recording channels. The buffer control can not let it lack data for the decoders, and it also cannot cause a buffer overflow due to excess of data sent. The integrity of the audios sent to the virtual audio cables is directly related to the automatic buffer control, which operates based on these parameters, because a shortage of data will result in skipping audio and a buffer overflow will result in muted audio.

84. http://www.connectmix.com.br
85. Smartphone applications with automatic, real time summaries of the hired monitoring.
86. Client log-in control, with username, password, and IP number. Each user may log in under one single IP number only.
87. Once connected to the Web server database, the user/client is submitted to the 10 rules associated to their registration, which restrict access to stations and phonograms.
88. Filter, used by the users to obtain more elaborate search results. In this module the imposition of the 10 rules system is more evident, as each user can access only the filtering options configured in their registration, thus the filter acts only on the hired stations and phonograms. FIG. 32
89. The user/client has access to the entry listings pertinent to their registration, such as: monitored stations table, monitored phonograms table, monitored agencies/artists table. FIG. 33 e 34

### 90. Reports.

Stations Connectivity History
Status monitoring (on-line, off-line and error), second by second, of each connected, monitored station. FIG. 35

Phonogram Monitoring
Data obtained by applying the existing Filter options, that is: queried by region, state, city, station, agency/artist, album, phonogram, identification percentage (short, medium, or long), type of phonogram (musical or commercial), musical genre, or date period. FIG. 36
Individualized data or summed up by: region, state, city, station, agency/artist, phonogram, and date/time. FIG. 37
Print-ready files in PDF and CSV, with printing preview and file download options.

### 91. Real Time Map

Developed in SVG (Scalable Vector Graphics) and programmed in JavaScript and PHP. We used this vector format because it is an open standard, not the property of a third party, and because of the characteristic of vector graphics which is not losing quality as they are expanded or shrunk.

Main considerations:

1. It has been implemented a JavaScript function that allows one to move the map to all directions with the mouse, saving the last position in the user preferences database.

2. It has been implemented a JavaScript function that allows one to drag countries and/or states from their original positions and drop them anywhere else in the map, with no deviation occurring to the latitude and longitude positions of the city markers originating from the monitoring process.

3. It has been implemented a JavaScript zooming function that allows one to adjust the size of the map to the display of the device being used.

4. A function has been implemented that allows one to adjust the size of all dynamic objects on the map: city markers, city names, information balloons, and animations. This way it is possible to comfortably use the map both in tiny smartphone screens as well as in big monitors and televisions.

5. The data is obtained via JavaScript and PHP, and it may be classified according to the filtering options, that is: queried by region, state, city, station, agency/artist, album, phonogram, type of phonogram (musical or commercial), musical genre, and date.

6. The user may request data manually by selecting a date on the map's calendar, or in real time with automatic requisitions in Real Time.

7. The latitude and longitude coordinates are pre-entered in the cities database, which is relative to the stations and phonograms, indicating the city where a phonogram is being identified by the monitoring process in the exact moment the phonogram is being played by the stations.

8. Clicking on the circle that indicates a city, we obtain a table containing all the monitoring data related to the stations present in this city and in the selected date. FIG. 38, 39, 40, 41 e 42

### 92. Timeline.

1. For this tool a data visualization plug-in is used, the free and open source SIMILE Widgets Timeline, developed in conjunction by MIT Libraries and CSAIL MIT.

2. This plug-in simulates horizontal or vertical background sliding panes, where each represents one timeline and one scale. All scales are dependent on one another, that is, repositioning one scale forces all others to reposition as well on the time determined by the first one.

3. Five different scales are used to compose this timeline: year, month, date, hour, and minute, the last one being responsible by the data visualization. And we have fixed the scales' sliding to the horizontal direction.

4. From navigation (rolling the scales) information will result: initial date visible to the left, current date centralized, and final date visible to the right. This information, when associated to the user filtering definitions, will classify the monitoring data for the selected period, and the plug-in is in charge of adding them to the MINUTE scale.

5. The user may manually request data through shifting one of the scales, or in Real Time with automatic requisitions.

6. When real time data requisition is activated, the timeline is forced to position itself centered to the date and time of Connect-Mix's Web server, disregarding the date and time from the user's computer. This way we can ensure all users will receive information on the exact moment they are happened, and while they are happening. FIG. 43, 44 e45

### 93. Graphics.

1. Connectivity.
a) 24 hours a day analysis of the four states, of all stations being monitored: connection, loading, audio failure, and disconnection. FIG. 46
b) 24 hours a day analysis of the four states, of every station individually. FIG. 47
c) Analysis of phonogram identification of every station individually. FIG. 48

2. Life statistics of a song.
a) Based on the monitoring data we obtain a quantitative, temporal analysis of every musical phonogram, and consequently the observation and forecasting of increase or decrease in popularity of these phonograms in the monitored stations. FIG. 49

### 94. Real Time Controller.

It acts over the modules: Maps, Graphs, and Timeline, to stop the user from opening various maps, graphs, and timelines, or even more than one of each at the same time and In Real Time, causing a decrease in the Web server's performance.

It works based on reading an ECO code.

The data requisition reaches the Web server and, along with the data, it receives a control code that must be informed on the next requisition. In case the user has more than one module operating in real time, the next requisition will inform the wrong code, and the data requisitions for these users will be deactivated, generating an alert on the device's screen.

The user may activate the requisition of real time data again, but they will have to keep just one of these modules active.

### 95. TOP 10 AND TOP 100 (TOP.EXE)

Installed on the Server Computer, its function is to calculate the TOP10 and the TOP100 of most played musical phonograms: by station, by state, by region, and by musical genre. It sends updated data to the Connect-Mix website database and to the main social network websites, such as: Orkut, Facebook, and Twitter.

96. WAV Repository. Files folder on the server, with the purpose of sharing the phonograms between the administrative and the monitoring computers.
97. Inactive Digital Fingerprints. Files folder on the Server, with the purpose of archiving the digital fingerprints of phonograms that are outside the contractual period.
98. Active Digital Fingerprints. Files folder on the Server, with the purpose of archiving the digital fingerprints of phonograms that are inside the contractual period.
99. Main database located on the Server CPU.
100. Decision based on the date and time originated from the monitoring process as to whether the predicted time for the complete placement of each phonogram identified in the monitoring process is over.
101. Invalidates the phonogram identifications that did not reach 10% of the total predicted time.
102. Marks the phonogram identifications for local exclusion and synchronizes their remote exclusion (Web).
103. Data entry of the configurations related to Web users/clients rights.
104. Accesses the WAV phonograms, decodes harmonics and creates the Digital Fingerprints of each phonogram.
105. Checks whether the phonogram is inside the contractual period.
106. Checks whether the group is connected.
107. Network cards of all computers in the monitoring process.
108. Operating system shutdown API.
109. Standard operating system audio device (Speakers).
110. Temporary database in all computers in the monitoring process.
111. Timed firing for data reading of every temporary database in 5 second intervals.

### 112. Web Database.

### 113. SECTOR: Database.

### 114. SECTOR: Applications and Systems.

### 115. SECTOR: Local Server.

### 116. SECTOR: Administrative.

### 117. SECTOR: Monitoring.

### 118. SECTOR: Results Visualization (Web Site, Smartphone Applications).

All subroutines composing the monitoring of audio streaming from Am and Fm radio and TV stations obey specific methods which are the object of the present patent request, as follows:

1. Audio stream monitoring control method, characterized by comprehending the following automated steps:
a) Initialization of the server computer.
b) Initialization of the tasks schedule that will determine in which dates and times the actions (c, d, e, f, g, h, i, j, k, l) will be executed by the monitoring system.
c) Initialization of the monitoring computers and their related station groups.
d) Initialization of the stations' audio stream players.
e) Initialization and parameterization of multiple simultaneous instances of the software Tyberis Music Database (TyMDB.exe) by the computer. Monitoring audio and connections of up to 256 stations' streams per monitoring computer.
f) Initialization of validation and data synchronization between the databases of the monitoring computers, the server, and the Web.
g) Finishing the players.
h) Finishing all instances of the software TyMDB.exe.
i) Finishing data synchronization.
j) Shutting down of the monitoring computers.
k) Backup of the server database.
l) Shutting down of the server computer.

2. Automation method for Tyberis Music Database (Software with distinct single user characteristics, with manual configuration, and a limit of 99 audio monitoring channels) characterized by comprehending the following automated steps:
a) Access to the HKEY_CURRENT_USER\Software\TyMDBPro3 key of the operational system registry, which holds the values relative to all parameters and configurations of the software TyMDB.exe.
b) Writing of the values predefined by the system operator to the keys relative to the server folders which contain the digital fingerprints database (Fingerprint database folder) and the phonograms (Folder for batch conversion).
c) Writing of the values predefined by the system operator to the keys relative to basic configurations (Miscellaneous Options).
d) Writing of the values predefined by the system operator to the keys relative to event configurations: Song Detected, Song Logged in History (Delayed), Start of Idle Time, End of idle Time, Duplicate unloaded, Duplicate disabled.
e) Writing of the value relative to the key that defines the amount of channels that will be monitored by each instance of the software (simultaneous channels). This value is defined by the number of stations in each group/monitoring computer, and the number of times it will be necessary to execute TyMDB.exe to monitor all stations in the group.
f) Writing of the values relative to each monitored channel and its virtual audio cables. The name of each monitored channel is the ID of one of the stations contained in the group.
   1. Example of a channel name
      Channe158=715
   2. Example of audio cable routing
      ChannelDevice58=Line 3 (Virtual Audio Cable)
g) Initialization of the Tyberis Music Database software.
So that each monitoring computer can monitor 256 stations using a software application that was developed to monitor a maximum of 99 stations and to be configured manually, it is necessary to execute three controlled instances of the software, two monitoring 99 stations each, and a third monitoring 58 stations. Each initialized instance of the software must mandatorily be preceded by the automated steps (a, b, c, d, e, f, g) of the automation method for Tyberis Music Database, claimed above.

3. Method for gauging and grouping, in real time, the data of audio identifications originating from the monitoring process, characterized by containing the following automated steps:

a. Classifying information into two groups:
1. Initial (without a time count).
   Identifications generated at the moment a phonogram is detected do not have a time duration, only the positions where the phonograms were identified.

2. Final (with a time count).
Generated at the ending of a phonogram's identification, they have a time duration and the position of the identification's ending.
   b. Analyzing each identification separately:
1. Initial type case.
   I. Calculate the precise date and time of beginning and ending of the execution of each identified phonogram:

beginning=d¹−p¹

ending=(d¹−p¹)+t¹
where d is the date and time of the identification, p¹ is the position where the digital fingerprint was identified in the phonogram, and t¹ is the time duration of the phonogram. The variables p¹ and t¹ are time measurements in the seconds scale.
II. Search in the server database for an identification entry of the same phonogram, in the same station, in which the date and time are contained within the calculated beginning and ending time intervals.
III. If an entry is not found, create a new one based on the analyzed identification information, and archive it in the server database.
IV. Discard the analyzed information from the temporary database.
2. Final type case.
   I. Calculate the precise date and time of beginning and ending of the execution of each identified phonogram:

beginning=d¹−p¹

ending=(d¹−p¹)+t¹
II. where d¹ is the date and time of the identification, p¹ is the position where the digital fingerprint was identified in the phonogram, and t¹ is the time duration of the phonogram. The variables p¹ and t¹ are time measurements in the seconds scale.
III. Search in the server database for an identification entry of the same phonogram, in the same station, in which the date and time are contained within the calculated beginning and ending time intervals.
IV. If an entry is found, add the time duration of the analyzed entry to the time duration of the found entry and, for internal statistical ends, increment 1 to the BREAKS field. It is possible to define this action as: “Mending Identification Breaks”.
V. If an entry is not found, create a new one based on the analyzed identification information, and archive it in the server database.
VI. Discard the analyzed information from the temporary database.
4. Method of data synchronization between the monitoring computers, the server, and the Web, characterized by comprehending the following automated steps:
   a) Gather the data relative to the audio identifications and the connectivity of the stations in each group into temporary databases contained in each of the monitoring computers.
   b) Send from each monitoring computer, in regular and controlled intervals, the gathered data to the server computer's database.
c) Eliminate, in each monitoring computer, the data in the temporary database that has been sent to the server database.
d) Send from the server computer, in regular and controlled intervals, the data from the server computer's database to the Web database.
5. Method to control access to the information contained in the Web database, characterized by comprehending the following steps:
   a. Registering users with logins and access passwords.
   b. Select for each user the desired access level to the stations:
      1. Total/National Level
      2. Regional Level
         Inform the allowed regions.
      3. State Level
         Inform the allowed states.
      4. City Level
         Inform the allowed cities.
      5. Station Level
         Inform the allowed stations.
   c. Select for each user the desired access level to the phonograms:
      1. Total Level
      2. Agency/Artist Level
         Inform the allowed agencies/artists.
      3. Album Level
         Inform the allowed albums.
      4. Phonogram Level
         Inform the allowed phonograms.
   d. Submit all queries made by the users to controlled access level validation, so that each user will only receive phonograms and stations information relative to their registration.
6. Method of geographical visualization of the identified phonograms in real time, characterized by comprehending the following steps:
   a. Registering all the cities that will be utilized into the radio and TV stations registry, each with their own latitude and longitude geographical coordinates.
   b. Associate individually the radio and TV stations to their relative cities.
   c. Associate all phonogram identifications with their relative stations and, consequently, their relative cities.
   d. Develop a webpage containing a geographical map with graphical references to the states and regions present in the cities registry.

1. Program functions for controlling map zoom and the size of all components used in the visualizations. Necessary so that the map will visually adjust to the many different devices that may use it.

2. Program mobility functions to the states, allowing users/clients to drag the states they wish outside of the original map configuration. Necessary so that better visibility can be obtained for the information balloons when large quantities of these are over the map. Or simply to highlight specific states.

3. Endow the map geographical coordinates localization algorithm with the ability to compensate for the displacement of the states when they are dragged outside of their original positions.

4. Endow the state displacement algorithm with the ability to move any component inserted over the states simultaneously with the displacement.

5. Program a timer with the task of maintaining the information over the map updated, with real time queries.

e. Query on the Web database the list of cities in which phonogram identification has occurred today (on the date) and fulfill a vector (v1) with the geographical coordinates of the cities listed.
f. Query on the Web database the list of phonograms that are still mathematically in execution and fulfill a vector (v2) with the geographical coordinates of their relative cities, and the information of each phonogram's identification, such as: name, agency/artist, station, date/time, and beginning and ending of the identification.
g. Fill in the map with information from the v1 and v2 vectors, where v1 creates the city indicators and v2 creates the information balloons and the animations indicating still in execution phonograms.

1. REAL TIME AUDIO MONITORING OF RADIO AND TV STATIONS is a computational system with memory to hold data for access by an application program, which is executed in a data processing system, and capable of monitoring audio transmissions, generating information and reports using software and hardware resources, especially the Server Computer, the Administrative Computers, and the Monitoring Computers. It is characterized by comprehending:
The Server CPU's BIOS, which is programmed to turn on the hardware every day in a pre-determined time by the system manager, and the Server CPU's operating system initializes a software application named SERVACT.EXE.
and by SERVACT.EXE assuming control of the automated procedures, accessing the database, initializing tasks selection and their chronological ordering, and initializing and monitoring another software named ODBCMONITOR.EXE;
and by ODBCMONITOR.EXE synchronizing the local database with the web database during the whole active processing of the system;
and SERVACT.EXE initializing the sending of Wake-on-LAN (Wol) messages to the monitoring computers;
and a software application named TyMDB.exe, which accesses the media files and generates digital fingerprints of the phonograms;
and a software application named CMCLOCK.EXE, installed on the Server Computer and on the Administrative and Monitoring Computers, which synchronizes the operational system time via NTP servers;
and a software application named ODBCREPARE.EXE, installed on the Server computer and on the administrative computers, which initializes and maintains the Web database;
and a software application named TOP.EXE, installed on the administrative computers, which accounts for the ranking of the musical phonograms;
and a software application named ARTISTAS.EXE, installed on the administrative computers, which registers and controls Agencies and Artists;
and a software application named CIDADES.EXE, installed on the administrative computers, which registers cities, latitudes, longitudes, and time zones;
and a software application named EMISSORAS.EXE, installed on the administrative computers, which registers radio and TV stations;
and a software application named USUARIOS.EXE, installed on the administrative computers, which registers users/clients;
and a software application named WRITEWAY.EXE, installed on the administrative computers, which converts and standardizes the mp3/wma files into WAV; and saves the WAV files in a folder located in the server and which is used as a phonogram repository;
and a software application named SERVPROG.EXE, installed on the administrative computers, which schedules tasks, in which a system operator configures the actions the monitoring process will execute in an automated manner;
and a software application named MONIGRUP.EXE, installed on the administrative computers, which generates visible and auditory alerts when one of the monitoring computers inadvertently interrupts its activities;
and a software application named CMSTREAM.EXE, installed on the monitoring computers, which checks on the server for the existence of updates related to the monitoring system; CMSTREAM.EXE also accesses the database to initialize the selection of tasks and their chronological ordering; CMSTREAM.EXE also selects the group of stations relative to each computer; CMSTREAM.EXE also checks for the availability of audio cables and associates one for each station contained in the group; CMSTREAM.EXE is also responsible for the automation of the software TyMDB.exe, and for automatically configuring all parameters related to the working of the latter through directly writing in the Windows registry and entering the codes;
and a software application named UPDATE.EXE, which calls CMSTREAM.EXE once the updates are finished.

2. REAL TIME AUDIO MONITORING OF RADIO AND TV STATIONS is a computational system characterized by comprehending an algorithm that analyses each piece of data originating from the monitoring process and makes comparisons of data/time, station, phonogram, size of a phonogram, and positioning of beginning and ending of an identification and then mathematically checks whether the time for the conclusion of a phonogram's execution has expired or is still active.

3. REAL TIME AUDIO MONITORING OF RADIO AND TV STATIONS, according to claim 2, and if the phonogram's execution is still active, characterized by trying to locate on the identifications database a previously created entry that might contain segmented information of one same execution of the phonogram, and if an entry is found, it will be updated with this information, and if it is not found, a new entry will be created based on this information;

4. REAL TIME AUDIO MONITORING OF RADIO AND TV STATIONS, according to claim 2, and if the phonogram's execution is inactive, characterized by creating a new entry, named beginning of identification entry.

5. REAL TIME AUDIO MONITORING OF RADIO AND TV STATIONS, according to claim 1, characterized by the formatting of reports, graphs, maps, timelines, and the ranking of musical phonograms to be published and made available in real time on a website, with options to rank individually, or by station, or by artist, or by composer, or by genre, or by state, or by region, or by period: week, month, and year.

6. REAL TIME AUDIO MONITORING OF RADIO AND TV STATIONS, according to claim 1, characterized by the audio stream monitoring control method, comprehending the following automated steps:
a) Initialization of the server computer.
b) Initialization of the tasks schedule that will determine in which dates and times the actions (c, d, e, f, g, h, i, j, k, l) will be executed by the monitoring system.
c) Initialization of the monitoring computers and their related station groups.
d) Initialization of the stations' audio stream players.
e) Initialization and parameterization of multiple simultaneous instances of the software Tyberis Music Database (TyMDB.exe) by computer. Monitoring the audio connections of up to 256 stations' streams by the monitoring computer.
f) Initialization of validation, and data synchronization between the databases of the monitoring computers, the server, and the Web.
g) Finishing the players.
h) Finishing all instances of the software TyMDB.exe.
i) Finishing data synchronization.
j) Shutting down of the monitoring computers.
k) Backup of the server database.
l) Shutting down of the server computer.

7. REAL TIME AUDIO MONITORING OF RADIO AND TV STATIONS, according to claim 1, characterized by the Tyberis Music Database automation method comprehending the following automated steps:
a) Accessing the HKEY_CURRENT_USER\Software\TyMDBPro3 key of the operational system registry, which holds the values relative to all parameters and configurations of the software TyMDB.exe.
b) Writing of the values predefined by the system operator to the keys relative to the server folders which contain the digital fingerprints database (Fingerprint database folder) and the phonograms (Folder for batch conversion).
c) Writing of the values predefined by the system operator to the keys relative to basic configurations (Miscellaneous Options).
d) Writing of the values predefined by the system operator to the keys relative to event configurations: Song Detected, Song Logged in History (Delayed), Start of Idle Time, End of idle Time, Duplicated unloaded, Duplicate disabled.
e) Writing of the value relative to the key that defines the amount of channels that will be monitored by each instance of the software (simultaneous channels). This value is defined by the number of stations in each group/monitoring computer, and the number of times it will be necessary to execute TyMDB.exe to monitor all stations in the group.
f) Writing of the values relative to each monitored channel and its virtual audio cables. The name of each monitored channel is the ID of one of the stations contained in the group.
g) Initialization of the Tyberis Music Database software.

8. REAL TIME AUDIO MONITORING OF RADIO AND TV STATIONS, according to claim 1, characterized by the method for gauging and group, in real time, the data of audio identifications originating from the monitoring process, characterized by containing the following automated steps:
a) Classifying information into two groups:
1. Initial (without a time count).
Identifications generated at the moment a phonogram is detected do not have a time duration, only the positions where the phonograms were identified.
2. Final (with a time count).
Generated at the ending of a phonogram's identification, they have a time duration and the position of the identification's ending.
b) Analyzing each identification separately:
1. Initial type case.
I. Calculate the precise date and time of beginning and ending of the execution of each identified phonogram:
beginning=d¹−p¹
ending=(d¹−p¹)+t¹
where d¹ is the date and time of the identification, p¹ is the position where the digital fingerprint was identified in the phonogram, and t¹ is the time duration of the phonogram. The variables p¹ and t¹ are time measurements in the seconds scale.
II. Search in the server database for an identification entry of the same phonogram, in the same station, in which the date and time are contained within the calculated beginning and ending time intervals.
III. If an entry is not found, create a new one based on the analyzed identification information, and archive it in the server database.
IV. Discard the analyzed information from the temporary database.
2. Final type case.
I. Calculate the precise date and time of beginning and ending of the execution of each identified phonogram:
beginning=d¹−p¹
ending=(d¹−p¹)+t¹
II. where d¹ is the date and time of the identification, p¹ is the position where the digital fingerprint was identified in the phonogram, and t¹ is the time duration of the phonogram. The variables p¹ and t¹ are time measurements in the seconds scale.
III. Search in the server database for an identification entry of the same phonogram, in the same station, in which the date and time are contained within the calculated beginning and ending time intervals.
IV. If an entry is found, add the time duration of the analyzed entry to the time duration of the found entry and, for internal statistical ends, increment 1 to the BREAKS field. It is possible to define this action as: “Mending Identification Breaks”.
V. If an entry is not found, create a new one based on the analyzed identification information, and archive it in the server database.
VI. Discard the analyzed information from the temporary database.

9. REAL TIME AUDIO MONITORING OF RADIO AND TV STATIONS, according to claim 1, characterized by the method of data synchronization between the monitoring computers, the server, and the Web, characterized by comprehending the following automated steps:
a) Gather the data relative to the audio identifications and the connectivity of the stations in each group into temporary databases contained in each of the monitoring computers.
b) Send from each monitoring computer, in regular and controlled intervals, the gathered data to the server computer's database.
c) Eliminate, in each monitoring computer, the data in the temporary database that has been sent to the server database.
d) Send from the server computer, in regular and controlled intervals, the data from the server computer's database to the Web database.

10. REAL TIME AUDIO MONITORING OF RADIO AND TV STATIONS, according to claim 1, characterized by the method to control access to the information contained in the Web database, characterized by comprehending the following steps:
a. Registering users with logins and access passwords.
b. Select for each user the desired access level to the stations:
1. Total/National Level
2. Regional Level
Inform the allowed regions.
3. State Level
Inform the allowed states.
4. City Level
Inform the allowed cities.
5. Station Level
Inform the allowed stations.
c. Select for each user the desired access level to the phonograms:
1. Total Level
2. Agency/Artist Level
Inform the allowed agencies/artists.
3. Album Level
Inform the allowed albums.
4. Phonogram Level
Inform the allowed phonograms.
d. Submit all queries made by the users to controlled access level validation, so that each user will only receive phonograms and stations information relative to their registration.

11. REAL TIME AUDIO MONITORING OF RADIO AND TV STATIONS, according to claim 1, characterized by the method of geographical visualization of the identified phonograms in real time, comprehending the following steps:
a. Registering all the cities that will be utilized into the radio and TV stations registry, each with their own latitude and longitude geographical coordinates.
b. Associate individually the radio and TV stations to their relative cities.
c. Associate all phonogram identifications with their relative stations and, consequently, their relative cities.
d. Develop a webpage containing a geographical map with graphical references to the states and regions present in the cities registry:
1. Program functions for controlling map zoom and the size of all components used in the visualizations. Necessary so that the map will visually adjust to the many different devices that may use it.
2. Program mobility functions to the states, allowing users/clients to drag the states they wish outside of the original map configuration. Necessary so that better visibility can be obtained for the information balloons when large quantities of these are over the map. Or simply to highlight specific states.
3. Endow the map geographical coordinates localization algorithm with the ability to compensate for the displacement of the states when they are dragged outside of their original positions.
4. Endow the state displacement algorithm with the ability to move any component inserted over the states simultaneously with the displacement.
5. Program a timer with the task of maintaining the information over the map updated, with real time queries.
e. Query on the Web database the list of cities in which phonogram identification has occurred today (on the date) and fulfill a vector (v1) with the geographical coordinates of the cities listed.
f. Query on the Web database the list of phonograms that are still mathematically in execution and fulfill a vector (v2) with the geographical coordinates of their relative cities, and the information of each phonogram's identification, such as: name, agency/artist, station, date/time, and beginning and ending of the identification.
g. Fill in the map with information from the v1 and v2 vectors, where v1 creates the city indicators and v2 creates the information balloons and the animations indicating still in execution phonog rams.
